(19) United States
(12) Patent Application Publication
(10) Pub. No.: US 2009/0226831 A1
(43) Pub. Date: Sep. 10, 2009

(54) PHOTOCURABLE COATING COMPOSITION, AND OVERPRINT AND PROCESS FOR PRODUCING SAME

(75) Inventor: Ryuki KAKINO, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/397,570

(22) Filed: Mar. 4, 2009

(30) Foreign Application Priority Data
Mar. 5, 2008 (JP) 2008-054205

(51) Int. Cl. G03G 5/147; G03G 13/00; G03G 11/00

(52) U.S. Cl. 430/66; 430/126.1; 430/104

(57) ABSTRACT

A photocurable coating composition is provided that includes (A) a photopolymerization initiator residue-containing polymer compound and (B) a polymerizable compound. There are also provided an overprint that includes an overprint layer formed by photocuring the photocurable coating composition on a printed material, and a process for producing an overprint that includes a step of obtaining an electrophotographically printed material by carrying out electrophotographic printing on a printing substrate, a step of coating the electrophotographically printed material with the photocurable coating composition, and a step of photocuring the photocurable coating composition.

### BACKGROUND OF THE INVENTION

1. Field of the Invention

The present invention relates to a photocurable coating composition, and to an overprint and a process for producing same. More particularly, the present invention relates to a photocurable coating composition that is curable upon exposure to actinic radiation such as an electron beam or UV rays. In particular, it relates to a photocurable coating composition for coating an image formed by depositing ink and/or toner on a printing substrate (image receiving substrate) by a method such as lithography, relief printing, intaglio printing, screen printing, inkjet, or electrophotography. More particularly, it relates to a photocurable overprint composition (overprint composition) particularly suitably used for coating a toner-based printed material printed by an electrophotographic process.

2. Description of the Related Art

In recent years, photocurable compositions, in particular UV curable compositions, have been used in a large number of applications. Examples thereof include printing inks, overcoat varnishes, paints, adhesives, and photoresists.

In particular, a printed material in which an overprint coating is applied on top of toner-based image information such as in an electrophotographic method so as to improve protection of a printed material and give surface gloss has been commercialized as an alternative product to a silver halide photographic print and is attracting attention.

In a standard method for forming a toner-based image, such as an electrophotographic process, an electrostatic charge is formed on a latent image retaining surface by uniformly charging a latent image retaining surface such as, for example, a photoreceptor. Subsequently, charge on the uniformly charged region is selectively released by a pattern of activation irradiation corresponding to an original image. The latent image charge pattern remaining on the surface corresponds to regions that have not been exposed to radiation. Subsequently, the photoreceptor is passed through one or a plurality of development housings containing toner, and since the toner is deposited on the charge pattern by electrostatic attractive force, the latent image charge pattern is visualized. Subsequently, the developed image is either fixed on an image-forming surface or transferred to a printing substrate such as, for example, paper and fixed thereto by an appropriate fixation technique, thus giving an electrophotographically printed material, that is, a toner-based printed material.

As a known method for protecting a printed material, applying an overprint coating to the printed material has been proposed. For example, JP-A-11-70647 (JP-A denotes a Japanese unexamined patent application publication.) and JP-A-2003-241414 propose a method such as an electrophotographic process, in which fixation is carried out after a transparent toner is transferred on top of a toner-based image, thus covering the surface.

Furthermore, JP-A-61-210365 proposes a method in which an overprint coating is applied by applying a liquid film coating that is curable by UV rays, etc. and polymerizing (crosslinking) a coating component by means of light.

Furthermore, JP-A-2005-321782 discloses an overprint composition comprising a radiation curable oligomer selected from the group consisting of trifunctional unsaturated acrylic resins, a radiation curable monomer selected from the group consisting of polyfunctional alkoxylated acrylic monomers and polyalkoxylated acrylic monomers, such as one type or a plurality of types of diacrylate or triacrylate, at least one type of photopolymerization initiator, and at least one type of surfactant.

On the other hand, with regard to a polymerization initiator, a photoinitiator obtained by an esterification reaction of a carboxylic acid-containing addition-polymerized polymer having a weight-average molecular weight of at least 5,000 with a hydroxy group-containing phenyl ketone compound is disclosed in JP-A-7-33811.

A copolymerizable monoacrylate photopolymerization initiator is also disclosed in European Patent No. 377191.

### BRIEF SUMMARY OF THE INVENTION

It is an object of the present invention to provide a photocurable coating composition giving excellent surface smoothness, non-tackiness (suppression of surface tackiness), and suppression of odor, an overprint obtained by using the photocurable coating composition, and a process for producing same.

The above-mentioned object has been attained by means described in [1 ], [9], [12], and [15], which are described together with [2] to [8], [10], [11], [13], and [14], which are preferred embodiments.

[1] A photocurable coating composition comprising (A) a photopolymerization initiator residue-containing polymer compound and (B) a polymerizable compound,
[2] the photocurable coating composition according to [1], wherein a photopolymerization initiator residue-containing monomer unit of the polymer compound comprises a residue selected from the group consisting of an onium salt, a borate salt, an imide structure-containing compound, a triazine structure-containing compound, an azo compound, a peroxide, a lophine dimer, and a benzoyl compound,
[3] the photocurable coating composition according to [1] or [2], wherein the photopolymerization initiator residue-containing monomer unit of the polymer compound has a content of 40 to 60 mole %,
[4] the photocurable coating composition according to any one of [1] to [3], wherein the polymer compound has a weight-average molecular weight of at least 1,000 but no greater than 100,000,
[5] the photocurable coating composition according to any one of [1] to [4], wherein the polymer compound has a content, relative to the solids content of the photocurable coating composition, of at least 1 wt % but no greater than 40 wt %,
[6] the photocurable coating composition according to any one of [1] to [5], wherein it has substantially no absorption in the visible region,
[7] an overprint comprising an overprint layer formed by photocuring the photocurable coating composition according to any one of [1] to [6] on a printed material,
[8] the overprint according to [7], wherein the overprint layer has a thickness of at least 1 μm but no greater than 10 μm,
[9] the overprint according to [7] or [8], wherein the overprint layer has substantially no absorption in the visible region,
[10] an overprint comprising an overprint layer formed by photocuring the photocurable coating composition according to any one of [1] to [6] on an electrophotographically printed material,
[11] the overprint according to [10], wherein the overprint layer has a thickness of at least 1 μm but no greater than 10 μm,
[12] the overprint according to [10] or [11], wherein the overprint layer has substantially no absorption in the visible region,
[13] a process for producing an overprint, the process comprising a step of coating a printed material with the photocurable coating composition according to any one of [1] to [6], and a step of photocuring the photocurable coating composition, and
[14] a process for producing an overprint, the process comprising a step of obtaining an electrophotographically printed material by carrying out electrophotographic printing on a printing substrate, a step of coating the electrophotographically printed material with the photocurable coating composition according to any one of [1] to [6], and a step of photocuring the photocurable coating composition.

### DETAILED DESCRIPTION OF THE INVENTION

The present invention is explained in detail below.

### Photocurable Coating Composition

The photocurable coating composition (hereinafter, also called simply a ‘coating composition’) of the present invention comprises (A) a photopolymerization initiator residue-containing polymer compound and (B) a polymerizable compound.

The photocurable coating composition of the present invention preferably has substantially no absorption in the visible region. ‘Having substantially no absorption in the visible region’ means either having no absorption in a visible region of 400 to 700 nm or having only a level of absorption in the visible region that does not cause any problem as a photocurable coating composition. Specifically, a 5 μm optical path length transmittance of the coating composition in a wavelength region of 400 to 700 nm is at least 70%, and preferably at least 80%.

The photocurable coating composition of the present invention may suitably be used as one for an overprint, and may particularly suitably be used as one for an overprint for an electrophotographically printed material.

When the photocurable coating composition of the present invention is used for forming an overprint layer on an electrophotographically printed material having an image area with a thickness of a toner, an overprint with excellent non-tackiness and surface smoothness and having luster and gloss can be obtained, and an impression that it is visually close to a conventional silver halide photographic print can be given.

Furthermore, when the photocurable coating composition of the present invention is used for a toner image having a layer of fuser oil on the image surface, an image-printed material that has excellent non-tackiness and surface smoothness, has luster and gloss, has little distortion, and is highly flexible can be given, and an overprint that is visually close to a silver halide photographic print can be obtained.

When a fuser oil layer is present on an image surface in a toner-based image such as in an electrophotographic method, since the surface of a printed material is hydrophobic and the surface energy is low, it is currently difficult to obtain a photocurable composition that satisfies all of curability, surface smoothness, strength, storage stability, etc.

However, even for a toner image with a fuser oil layer on the image surface, the photocurable coating composition of the present invention can give an overprint that gives an image-printed material that is excellent in non-tackiness and surface smoothness, has luster and gloss, little distortion, and high flexibility, and that is visually close to a silver halide photographic print.

Furthermore, in particular, when an overprint coating is applied onto toner-based image information to thus serve as an alternative product to a silver halide photographic print, since a consumer handles it directly, product safety and odor are counted as important product qualities.

As a cause of the occurrence of an odor, there can be cited a residual volatile compound such as a polymerizable compound monomer (uncured monomer), a decomposition product of a polymerization initiator that is not incorporated into a resin in a cured coating due to lack of copolymerizability with a curable composition, etc.

The photocurable coating composition of the present invention gives excellent surface smoothness and non-tackiness (suppression of surface tackiness) and can suppress odor in an overprint by using a polymerization initiator residue-containing polymer compound.

### (A) Photopolymerization Initiator Residue-Containing Polymer Compound

The photocurable coating composition of the present invention (hereinafter, also called simply a ‘coating composition’) comprises a photopolymerization initiator residue-containing polymer compound (hereinafter, also called a ‘specific initiator’).

The photopolymerization initiator referred to here denotes a compound that has the conventionally known function of a photopolymerization initiator in generating a radical by optical energy, and starting and promoting polymerization of a polymerizable unsaturated group-containing compound, and a compound that generates an acid by optical energy and causes cationic polymerization.

The photopolymerization initiator residue-containing polymer compound comprises a photopolymerization initiator residue-containing monomer unit, and the monomer unit preferably comprises a residue selected from the group consisting of an onium salt, a borate salt, an imide structure-containing compound, a triazine structure-containing compound, an azo compound, a peroxide, a lophine dimer, and a benzoyl compound.

A detailed explanation is given below.

### Onium Type Specific Initiator

Preferred examples of the specific initiator used in the present invention include an initiator comprising an onium salt as a monomer unit (onium type specific initiator). It may be a polymer compound comprising a cationic parent nucleus of an onium salt in a side chain, or a polymer compound comprising a counteranion in a side chain.

### Onium Type Specific Initiator Comprising Counteranion in Side Chain

As the onium type specific initiator comprising a counteranion in a side chain, a polymer compound comprising a structure represented by Formula (I) below can be cited.

*-Z⁻M⁺ Formula (I)

In Formula (I), Z⁻ denotes COCOO⁻, COO⁻, SO₃⁻, or SO₂—N⁻—R, and R denotes a monovalent organic group. As the monovalent organic group, an alkyl group having 1 to 6 carbon atoms, an aryl group having 6 to 20 carbon atoms, a carboxyl group, R¹—CO—O—, R¹—O—CO—, R¹—O—, R¹—S—, and R¹—CO— (here, R¹ is an aliphatic group (e.g. an alkyl group, an alkenyl group, an alkynyl group, etc.) or aromatic group (e.g. a phenyl group, a naphthyl group, etc.) having no greater than 20 carbon atoms) can be cited, and among them a methyl group, an ethyl group, a propyl group, R¹—CO—O—, and R¹—CO— can be cited as preferred examples. These monovalent organic groups may further have a substituent selected from the group consisting of a hydroxy group, a carboxyl group, R¹—CO—O—, R¹—O—CO—, R¹—O—, R¹—S—, and R¹—CO— (here, R¹ is an aliphatic group (e.g. an alkyl group, an alkenyl group, an alkynyl group, etc.) or aromatic group (e.g. a phenyl group, a naphthyl group, etc.) having no greater than 20 carbon atoms).

M⁺ denotes an onium cation. Specifically, it is a cation selected from sulfonium, iodonium, diazonium, azinium, phosphonium, ammonium, etc.

Furthermore, * denotes a position of bonding to the side chain.

The azinium referred to here is one containing an azine ring, which is a nitrogen atom-containing six-membered ring, in the structure, and includes pyridinium, diazinium, and triazinium. Furthermore, the azinium is one containing at least one aromatic ring condensed with an azine ring, and examples thereof include quinolinium, isoquinolinium, benzoazinium, and naphthoazinium. Specific examples thereof include those described in U.S. Pat. No. 4,743,528, JP-A-63-138345, JP-A-63-142345, JP-A-63-142346, and JP-B-46-42363 (JP-B denotes a Japanese examined patent application publication), and further include countercations forming N-alkoxypyridinium salts such as 1-methoxy-4-phenylpyridinium tetrafluoroborate, etc.

Furthermore, as a preferred onium cation in the present invention, a diazonium ion, an iodonium ion, and a sulfonium ion represented by Formulae (RI-1) to (RI-3) below can be cited.

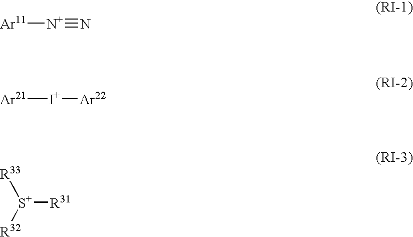

In Formula (RI-1), Ar¹¹ denotes an aryl group having no greater than 20 carbon atoms, which may have 1 to 6 substituents. Preferred examples of the substituent include an alkyl group having 1 to 12 carbon atoms, an alkenyl group having 2 to 12 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, a halogen atom, an alkylamino group having 1 to 12 carbon atoms, a dialkylamino group having 2 to 24 carbon atoms, an arylamino group having 6 to 12 carbon atoms, a diarylamino group having 12 to 24 carbon atoms, an alkylamide group or arylamide group having no greater than 12 carbon atoms, an alkylcarbonyl group having 2 to 13 carbon atoms, an arylcarbonyl group having 7 to 13 carbon atoms, a carboxy group, a cyano group, a sulfonyl group, a thioalkyl group having no greater than 12 carbon atoms, and a thioaryl group having no greater than 12 carbon atoms.

In Formula (RI-2), Ar²¹ and Ar²² independently denote an aryl group having no greater than 20 carbon atoms, which may have 1 to 6 substituents. Preferred examples of the substituent when this aryl group has a substituent include an alkyl group having 1 to 12 carbon atoms, an alkenyl group having 2 to 12 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, a halogen atom, an alkylamino group having 1 to 12 carbon atoms, a dialkylamino group having 2 to 24 carbon atoms, an alkylamide group or arylamide group having no greater than 12 carbon atoms, an alkylcarbonyl group or arylcarbonyl group having no greater than 12 carbon atoms, a carboxy group, a cyano group, a sulfonyl group, a thioalkyl group having no greater than 12 carbon atoms, and a thioaryl group having no greater than 12 carbon atoms.

In Formula (RI-3), R³¹, R³², and R³³ may be identical to or different from each other, denote an aryl group, alkyl group, alkenyl group, or alkynyl group having no greater than 20 carbon atoms, which may have 1 to 6 substituents, and are preferably aryl groups from the viewpoint of reactivity and safety. Preferred examples of the substituent that can be introduced include an alkyl group having 1 to 12 carbon atoms, an alkenyl group having 2 to 12 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, a halogen atom, an alkylamino group having 1 to 12 carbon atoms, a dialkylamino group having 2 to 24 carbon atoms, an alkylamide group or arylamide group having no greater than 12 carbon atoms, an alkylcarbonyl group or arylcarbonyl group having no greater than 12 carbon atoms, a carboxy group, a cyano group, a sulfonyl group, a thioalkyl group having no greater than 12 carbon atoms, a thioaryl group having no greater than 12 carbon atoms, and a hydroxy group.

From the viewpoint of reactivity, it is preferable that R³¹, R³², and R³³ are all aryl groups, and that at least one thereof has a substituent having a Hammett substituent constant (σ) of greater than 0.

Among the above-mentioned oniums, from the viewpoint of a balance between reactivity and safety, a sulfonium cation represented by Formula (RI-4) below is most preferable.

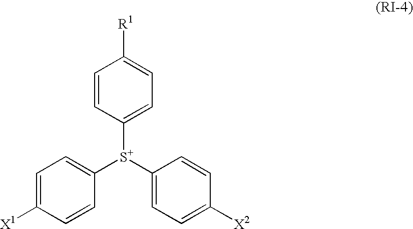

In Formula (RI-4) above, R¹ denotes an alkyl group having 1 to 8 carbon atoms, and X¹ and X² independently denote a halogen atom.

When such a structure is linked to a polymer, it is preferable that Z⁻ is linked to the polymer. A polymer as a main chain is not particularly limited, and it may be any polymer such as a urethane polymer, an amide polymer, an acrylic polymer, a methacrylic polymer, a styrene polymer, a butyral polymer, or a novolac resin.

At least some of the monomer units forming these polymer main chains may have a side chain structure represented by Formula (I) above.

In the present invention, the specific initiator may comprise a monomer unit (structural unit) that does not have a side chain structure represented by Formula (I) above, but it is preferable that a monomer unit (structural unit) having a side chain structure represented by Formula (I) is at least 50 mole %, more preferably at least 60 mole %, yet more preferably at least 70 mole %, and particularly preferably at least 80 mole %.

As an onium type specific initiator having a counteranion in a side chain, a polymer compound comprising a monomer unit (structural unit) represented by Formula (II) below is preferable.

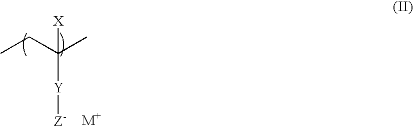

In Formula (II), X denotes a hydrogen atom or a monovalent organic group. When X denotes a monovalent organic group, examples of X include a hydroxy group, a halogen atom, an amino group, an amide group, a sulfonyl group, a sulfonate group, an alkyl group having 1 to 6 carbon atoms, an aryl group having 6 to 20 carbon atoms, a carboxyl group (—COOH), —NH—C(═O)—NHR¹, —O—(C═O)—R¹, R¹—CO—NH—, R¹—CO—O—, R¹—O—CO—, R¹—O—, and R¹—S-(here, R¹ is an aliphatic group (e.g. an alkyl group, an alkenyl group, an alkynyl group) or aromatic group (e.g. a phenyl group, a naphthyl group) having no greater than 20 carbon atoms).

Among them, preferred examples of X include a hydrogen atom, a methyl group, an ethyl group, a propyl group, R¹—CO—O—, R¹—O—CO—, and a carboxyl group. In addition, the monovalent organic group may have a substituent, and examples of the substituent include monovalent organic groups exemplified as X.

Y denotes a single bond or a divalent organic linking group. When Y is a single bond, Z⁻, which is a side chain structure thereof, is linked to a polymer main chain via the single bond. Examples of Y include an ether bond (—O—), —SO₂—, —(C═O)—, —NH—, an alkylene group, alkenylene group, or alkynylene group having no greater than 14 carbon atoms, an arylene group having 6 to 20 carbon atoms, and a group formed by combining the above (e.g. —(C═O)—O—, —SO₂—O—, —(C═O)—NH—), and these organic linking groups may further be substituted with an alkyl group, an alkenyl group, an alkynyl group, an aryl group, an alkoxy group, an aryloxy group, a sulfonate group, an amide group, a sulfonyl group, an alkylcarbonyl group, an arylcarbonyl group, a carboxyl group, an alkylthio group, an arylthio group, a hydroxy group, an alkylamide group, an arylamide group, an N-acylamino group, an alkoxycarbonyl group, an aryloxycarbonyl group, a halogen atom, an amino group, or a substituent formed by combining 2 to 5 of the above.

Z⁻ denotes COCOO⁻, COO⁻, SO₃⁻, or SO₂—N⁻—R; here, R denotes a monovalent organic group, and this monovalent organic group has the same meaning as that of the monovalent organic group denoted by X above. From the viewpoint of a balance between reactivity and safety, Z⁻ is preferably a COCOO⁻ structure.

M⁺ denotes an onium cation. Specifically, it is a cation selected from sulfonium, iodonium, diazonium, azinium, phosphonium, ammonium, etc.

In the present invention, the specific initiator may comprise only a monomer unit having a side chain structure represented by Formula (I), or only a monomer unit represented by Formula (II), which is a preferred example of the above, but may be a copolymer with various other known monomers.

### Onium Type Specific Initiator Having Cationic Parent Nucleus in Side Chain

The specific initiator may be a polymer compound comprising an onium salt cationic parent nucleus in a side chain, and as an onium type specific initiator having a cationic parent nucleus in a side chain, a polymer compound comprising a structure represented by Formula (III) below can be cited.

*-M⁺Z⁻ Formula (III)

Here, M⁺ denotes an onium cation. Specific examples thereof include a cation selected from sulfonium, iodonium, diazonium, azinium, phosphonium, ammonium, etc. Preferred examples of M⁺ include diazonium and/or azinium.

Z⁻ is a counterion and may be selected from the group consisting of a halide ion, a perchlorate ion, a tetrafluoroborate ion, a hexafluorophosphate ion, a sulfonate ion, and a carboxylate ion. The examples of Z⁻ include B(C₆F₅)₄⁻, PF₆⁻, AsF₆⁻, SbF₆⁻, CF₃SO₃⁻, and an organic anion comprising —COCOO⁻, —COO⁻, —SO₃⁻, or —SO₂—N⁻—R¹ (here, R¹ is an aliphatic group (e.g. an alkyl group, an alkenyl group, an alkynyl group) or aromatic group (e.g. a phenyl group, a naphthyl group) having no greater than 20 carbon atoms).

* denotes a position of bonding to a side chain.

As the specific initiator having an onium salt cationic parent nucleus in a side chain, a polymer compound comprising a monomer unit represented by Formula (IV) below can be cited.

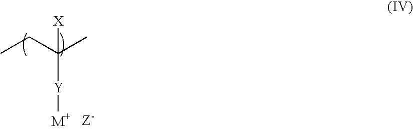

In Formula (IV), X and Y have the same meanings as those of X and Y in Formula (II), and preferred ranges thereof are also the same.

In Formula (IV), M⁺ denotes an onium cation. Specifically, it is sulfonium, iodonium, diazonium, azinium, phosphonium, or ammonium. Preferred examples of M⁺ include diazonium and/or azinium.

In Formula (IV), Z⁻ is a counterion selected from the group consisting of a halide ion, a perchlorate ion, a tetrafluoroborate ion, a hexafluorophosphate ion, a sulfonate ion, and a carboxylate ion. Specific examples thereof include B(C₆F₅)₄⁻, PF₆⁻, AsF₆⁻, SbF₆⁻, CF₃SO₃⁻, and an organic anion comprising —COCOO⁻, —COO⁻, —SO₃⁻, or —SO₂—N⁻—R¹ (here, R¹ is an aliphatic group (e.g. an alkyl group, an alkenyl group, an alkynyl group) or aromatic group (e.g. a phenyl group, a naphthyl group) having no greater than 20 carbon atoms).

In Formula (IV), preferred examples of M⁺ include azinium, and as M⁺ there can be cited as an example a residue formed by removing one hydrogen atom from an azinium compound. The azinium compound referred to here is one having in its structure an azine ring, which is a nitrogen atom-containing six-membered ring, and examples thereof include a compound having a group formed by removing one hydrogen atom from pyridinium, diazinium, or triazinium. Furthermore, the azinium compound includes a compound having at least one aromatic ring condensed with an azine ring, and examples thereof include a compound having a group formed by removing one hydrogen atom from quinolinium, isoquinolinium, benzoazinium, or naphthoazinium. Moreover, a hydrogen atom on a ring in these residues may further be substituted.

In the present invention, M⁺ is preferably a pyridinium residue represented by Formula (V-1) below.

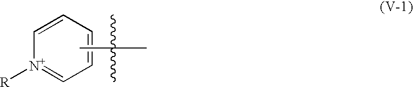

In Formula (V-1) above, R denotes an alkyl group having 1 to 12 carbon atoms or an aryl group having 6 to 20 carbon atoms, and the alkyl group and aryl group may further have a substituent. Examples of the substituent include a halogen atom, an alkyl group having 1 to 12 carbon atoms, and an aryl group having 6 to 20 carbon atoms. The triazine ring may have a substituent, and examples of the substituent include a halogen atom, a nitro group, an alkyl group having no greater than 12 carbon atoms, an alkoxy group having no greater than 12 carbon atoms, an aryloxy group having no greater than 12 carbon atoms, an alkylamino group having no greater than 12 carbon atoms, a dialkylamino group having no greater than 24 carbon atoms, an alkylarylamino group having no greater than 20 carbon atoms, and a diarylamino group having no greater than 40 carbon atoms.

A specific initiator in which M⁺ is azinium may be obtained by polymerizing an ethylenically unsaturated group-containing azinium salt. The specific initiator is not limited to a homopolymer; it may be a copolymer, and a copolymerizable monomer is not particularly limited.

In Formula (IV), preferred examples of M⁺ include diazonium; it is not particularly limited as long as it has a diazo group (—N⁺≡N) in a side chain, but it preferably has a structure represented by Formula (V-2) below.

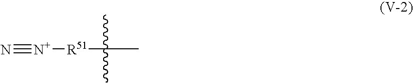

In Formula (V-2), R⁵¹ denotes an optionally substituted arylene group having no greater than 20 carbon atoms. Preferred examples of the substituent include a halogen atom, a nitro group, an alkyl group having no greater than 12 carbon atoms, an alkoxy group having no greater than 12 carbon atoms, an aryloxy group having no greater than 12 carbon atoms, an alkylamino group having no greater than 12 carbon atoms, a dialkylamino group having no greater than 12 carbon atoms, an arylamino group having no greater than 12 carbon atoms, and a diarylamino group having no greater than 12 carbon atoms.

In the present invention, the specific initiator may comprise only a monomer unit having a side chain structure represented by Formula (III) or only a monomer unit represented by Formula (IV), which is a preferred example thereof, but may be a copolymer with various other known monomers. Examples of copolymerizable monomers include radically polymerizable monomer units selected from acrylic acid esters, methacrylic acid esters, acrylamides, methacrylamides, styrenes, acrylonitriles, methacrylonitriles, etc.

### Non-Onium Type Specific Initiator

Preferred examples of a non-onium type specific initiator include specific initiators in which the polymerization initiator residue-containing monomer unit comprises a residue selected from the group consisting of a borate salt, an imide structure-containing compound, a triazine structure-containing compound, an azo compound, a peroxide, a lophine dimer, and a benzoyl compound. Among them, a borate salt, an imide structure-containing compound, a triazine structure-containing compound, an azo compound, a peroxide, and a lophine dimer are preferable, and an imide structure-containing compound, a triazine structure-containing compound, a peroxide, and a lophine dimer are more preferable.

Each thereof is explained in detail below.

### Borate Salt Specific Initiator

As a specific initiator in which a polymerization initiator residue-containing monomer unit is a borate salt compound residue (also called a borate salt specific initiator), a specific initiator comprising a monomer unit represented by Formula (VI) below is preferable.

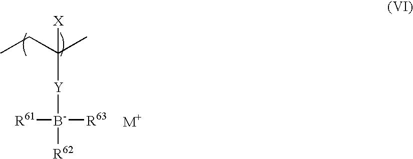

In Formula (VI), R⁶¹, R⁶², and R⁶³ may be identical to or different from each other, each denotes a substituted or unsubstituted alkyl group, a substituted or unsubstituted aryl group, a substituted or unsubstituted alkenyl group, a substituted or unsubstituted alkynyl group, or a substituted or unsubstituted heterocyclic group, and two or more groups of R⁶¹, R⁶², and R⁶³ may be bonded to form a cyclic structure. M⁺ denotes an alkali metal cation or a quaternary ammonium cation. Furthermore, X and Y have the same meanings as those of X and Y in Formula (II), and preferred ranges are also the same. At least one of R⁶¹, R⁶², R⁶³, and Y is a group in which a linking group to the boron is a saturated aliphatic group.

As the alkyl group denoted by R⁶¹ to R⁶³ above, straight-chain, branched, and cyclic groups are included, and one having 1 to 18 carbon atoms is preferable. Specific examples thereof include methyl, ethyl, propyl, isopropyl, butyl, pentyl, hexyl, octyl, stearyl, cyclobutyl, cyclopentyl, and cyclohexyl. As the substituted alkyl group, alkyl groups as above that have as a substituent a halogen atom (e.g. —Cl, —Br, etc.), a cyano group, a nitro group, an aryl group (preferably a phenyl group), a hydroxy group, —NR⁶⁴R⁶⁵ (R⁶⁴ and R⁶⁵ independently denote a hydrogen atom, an alkyl group having 1 to 14 carbon atoms, or an aryl group), —COOR⁶⁶ (R⁶⁶ denotes a hydrogen atom, an alkyl group having 1 to 14 carbon atoms, or an aryl group), —OCOR⁶⁷ or —OR⁶⁸ (here R⁶⁷ and R⁶⁸ denote an alkyl group or an aryl group having no greater than 14 carbon atoms) are included.

As the aryl group denoted by R⁶¹ to R⁶³ above, mono- to tri-cyclic aryl groups such as a phenyl group and a naphthyl group are included, and as the substituted aryl group, aryl groups as above that have a substituent described above for the substituted alkyl group or an alkyl group having 1 to 14 carbon atoms are included.

As the alkenyl group denoted by R⁶¹ to R⁶³ above, straight-chain, branched, and cyclic groups having 2 to 18 carbon atoms are included, and as a substituent of the substituted alkenyl group, substituents described above for the substituted alkyl group are included.

As the alkynyl group denoted by R⁶¹ to R⁶³ above, straight-chain and branched groups having 2 to 28 carbon atoms are included, and as a substituent of the substituted alkynyl group, substituents described above for the substituted alkyl group are included.

Furthermore, as the heterocyclic group denoted by R⁶¹ to R⁶³ above, a 5- or higher-membered ring containing at least one of N, S, and O can be cited; a 5 to 7-membered heterocyclic group is preferable, and this heterocyclic group may include a condensed ring. It may further have as a substituent a substituent described above for the substituted aryl group.

Among them, it is preferable that R⁶¹ to R⁶³ are phenyl groups.

### Imide Structure-Containing Specific Initiator

In the present invention, the specific initiator may be a polymer compound in which the photopolymerization initiator residue-containing monomer unit comprises an imide structure-containing compound residue (hereinafter, also called an ‘imide structure-containing specific initiator’).

Examples of the imide structure-containing specific initiator include a polymer compound having an imide residue in a side chain, and a specific initiator comprising a monomer unit represented by Formula (VII) below is preferable.

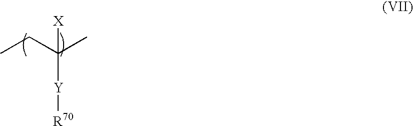

In Formula (VII), X and Y have the same meanings as those of X and Y in Formula (II), and preferred ranges are also the same.

In Formula (VII), R⁷⁰ denotes an imide residue, and examples thereof include imide residues represented by Formulae (VII-1) to (VII-4) below.

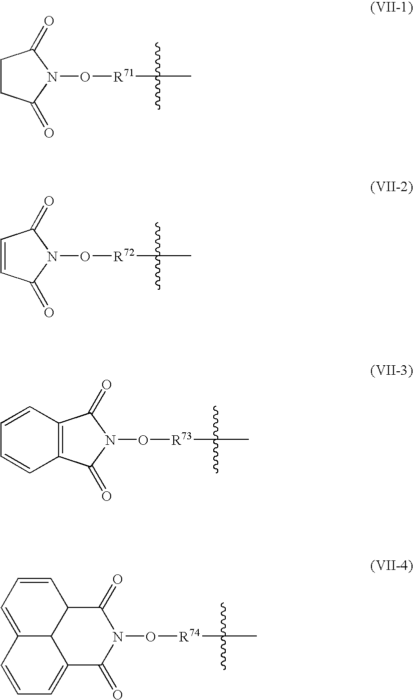

In Formulae (VII-1) to (VII-4), R71, R72 and R73 denote a carbonyl group (—CO—) or —SO₂—.

Moreover, the imide structure-containing specific initiator may be obtained by polymerizing an imide structure- and ethylenically unsaturated group-containing monomer. The imide structure-containing specific initiator is not limited to a homopolymer; it may be a copolymer, and a copolymerizable monomer is not particularly limited.

### Triazine Structure-Containing Specific Initiator

In the present invention, the specific initiator may be a polymer compound in which the photopolymerization initiator residue-containing monomer unit comprises a triazine structure-containing compound residue (hereinafter, also called a ‘triazine structure-containing specific initiator’).

Examples of the triazine structure-containing specific initiator include a polymer compound having a triazine residue in a side chain, and a specific initiator comprising a monomer unit represented by Formula (VIII) below is preferable.

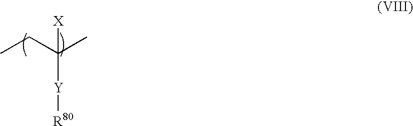

In Formula (VIII), X and Y have the same meanings as those of X and Y in Formula (II), and preferred ranges are also the same.

In Formula (VIII), R⁸⁰ denotes a triazine residue, and the triazine residue is preferably a group represented by Formula (VIII-1) below.

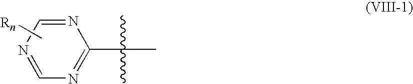

In Formula (VIII-1) above, R denotes a monovalent substituent, and examples of the substituent include a halogen atom, an alkyl group having 1 to 6 carbon atoms, and an aryl group having 6 to 12 carbon atoms. The alkyl group and aryl group may further have a substituent, and examples of the substituent include a halogen atom. n denotes an integer of 0 to 2.

As the triazine structure-containing specific initiator, a polymer compound comprising a monomer unit having the above group in a side chain can be cited, and with regard to bonding to a main chain, a single bond or the same linking group as for Y in Formula (II) above can be cited.

Furthermore, the triazine structure-containing specific initiator may be obtained by polymerizing a triazine structure- and ethylenically unsaturated group-containing monomer. The triazine structure-containing specific initiator is not limited to a homopolymer; it may be a copolymer, and is not particularly limited.

### Azo Specific Initiator

In the present invention, the specific initiator may be a polymer compound in which the photopolymerization initiator residue-containing monomer unit comprises an azo compound residue (hereinafter, also called an ‘azo specific initiator’).

The azo compound is not particularly limited as long as it has an azo group (—N═N—) in the structure. The azo specific initiator may be a polymer compound in which the monomer unit has an azo group in a main chain or in a side chain. Among them, a compound in which an azo group is in a main chain is preferable.

Preferred examples thereof include a specific initiator having in a main chain a partial structure represented by Formula (IX) below.

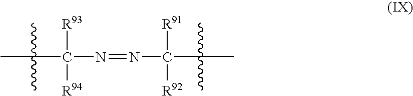

In Formula (IX), R⁹¹, R⁹², R⁹³, and R⁹⁴ independently denote an alkyl group having no greater than 12 carbon atoms or a cyano group, preferably an alkyl group having 1 to 4 carbon atoms or a cyano group, and more preferably a methyl group or a cyano group.

The azo specific initiator may be synthesized by reference to a method described in JP-A-2005-097518.

### Peroxide Specific Initiator

In the present invention, the specific initiator may be a polymer compound in which the photopolymerization initiator residue-containing monomer unit comprises a peroxide residue (hereinafter, also called a ‘peroxide specific initiator’).

The peroxide is not particularly limited as long as it has an —O—O— structure in the structure, but is preferably one comprising a —(C═O)—O—O—H structure.

The peroxide specific initiator is preferably a specific initiator comprising a monomer unit represented by Formula (X) below.

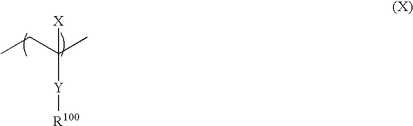

In Formula (X), X and Y have the same meanings as those of X and Y in Formula (II) above, and preferred ranges are also the same. R¹⁰⁰ is represented by Formula (X-1) below.

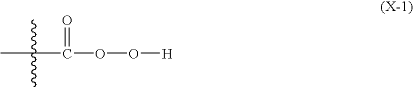

The peroxide specific initiator is not limited to a homopolymer of a monomer unit represented by Formula (X) above; it may be a copolymer, and a copolymerizable monomer is not particularly limited.

### Lophine Dimer Specific Initiator

In the present invention, the specific initiator may be a polymer compound in which the photopolymerization initiator residue-containing monomer unit comprises a lophine dimer residue (hereinafter, also called a ‘lophine dimer specific initiator’).

The lophine dimer specific initiator preferably comprises a monomer unit represented by Formula (XI) below.

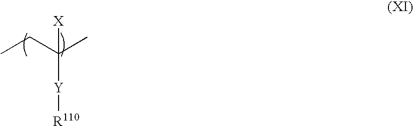

In Formula (XI), X and Y have the same meanings as those of X and Y in Formula (II), and preferred ranges are also the same.

Furthermore, in Formula (XI), R¹¹⁰ is a group formed by removing one hydrogen atom from a structure represented by Formula (XI-1) below (lophine dimer residue).

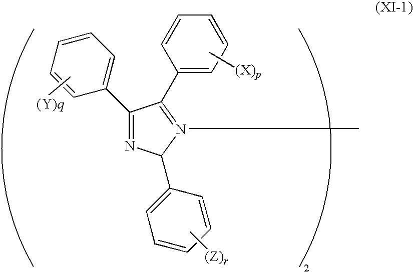

In Formula (XI-1), X, Y, and Z independently denote an alkyl group, an alkoxy group, or a halogen atom, and p, q, and r are integers of 0 to 5.

Moreover, the lophine dimer specific initiator may be obtained by polymerizing a lophine dimer residue—and ethylenically unsaturated group-containing monomer. The lophine dimer specific initiator is not limited to a homopolymer; it may be a copolymer, and a copolymerizable monomer is not particularly limited.

### Benzoyl Specific Initiator

In the present invention, the specific initiator may be a polymer compound in which the photopolymerization initiator residue-containing monomer unit comprises a benzoyl compound residue (hereinafter, also called a ‘benzoyl specific initiator’).

The benzoyl compound is not particularly limited as long as it is a benzoyl group-containing compound, but preferably comprises a monomer unit by Formula (XII) below.

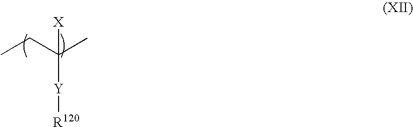

In Formula (XII), X and Y have the same meanings as those of X and Y in Formula (II), and preferred ranges are also the same. R¹²⁰ is a group represented by Formula (XII-1) to Formula (XII-3) below.

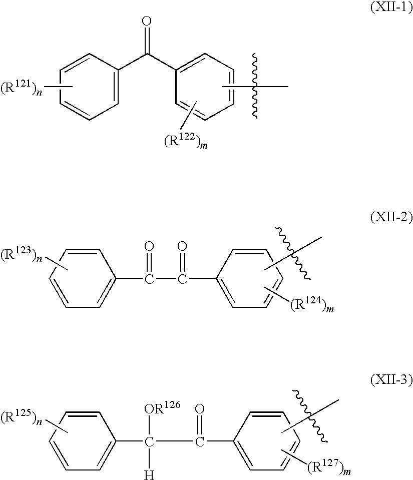

In Formula (XII-1) to Formula (XII-3) above, R¹²¹, R¹²², R¹²³, R¹²⁴, R¹²⁵, and R¹²⁷ independently denote a halogen atom, a carboxyl group, an alkyl group having no greater than 12 carbon atoms, an alkoxy group having no greater than 12 carbon atoms, an aryloxy group having no greater than 12 carbon atoms, an alkylthio group having no greater than 12 carbon atoms, an arylthio group having no greater than 12 carbon atoms, a dialkylamino group having no greater than 12 carbon atoms, an acyloxy group having no greater than 12 carbon atoms, or an aryloxycarbonyl group having no greater than 12 carbon atoms; the above-mentioned alkyl group, alkoxy group, aryloxy group, alkylthio group, arylthio group, dialkylamino group, acyloxy group and aryloxycarbonyl group may further have a substituent, and examples of the substituent include groups cited for R¹²¹, R¹²², R¹²³, R¹²⁴, R¹²⁵, and R¹²⁷. n denotes an integer of 0 to 5, and m denotes an integer of 0 to 4. Furthermore, R¹²¹ and R¹²² may be bonded to each other to form a ring, and a ring thus formed may be a sulfur atom- or nitrogen atom-containing heterocycle.

In Formula (XII-3), R¹²⁶ denotes a hydrogen atom or an alkyl group having 1 to 6 carbon atoms. Preferred examples of R¹²¹, R¹²², R¹²³, R¹²⁴, R¹²⁵, and R¹²⁷ include a halogen atom, a carboxyl group, an alkoxycarbonyl group, a dialkylamino group, and an arylthio group.

The benzoyl specific initiator is not limited to a homopolymer of a monomer unit represented by Formula (XII) above; it may be a copolymer, and a copolymerizable monomer is not particularly limited.

### Copolymer Component

In the present invention, the specific initiator may be a homopolymer comprising only a photopolymerization initiator residue-containing monomer unit or may be a copolymer comprising another monomer unit. Examples of copolymerizable monomers include radically polymerizable monomer units selected from acrylic acid esters, methacrylic acid esters, acrylamides, methacrylamides, styrenes, acrylonitriles, methacrylonitriles, etc.

Specific examples thereof include acrylic acid esters such as alkyl acrylates (the alkyl group preferably having 1 to 20 carbon atoms) (specific examples thereof include benzyl acrylate, 4-biphenyl acrylate, butyl acrylate, sec-butyl acrylate, t-butyl acrylate, 4-t-butylphenyl acrylate, 4-chlorophenyl acrylate, pentachlorophenyl acrylate, 4-cyanobenzyl acrylate, cyanomethyl acrylate, cyclohexyl acrylate, 2-ethoxyethyl acrylate, ethyl acrylate, 2-ethylhexyl acrylate, heptyl acrylate, hexyl acrylate, isobornyl acrylate, isopropyl acrylate, methyl acrylate, 3,5-dimethyladamantyl acrylate, 2-naphthyl acrylate, neopentyl acrylate, octyl acrylate, phenethyl acrylate, phenyl acrylate, propyl acrylate, tolyl acrylate, amyl acrylate, tetrahydrofurfuryl acrylate, 2-hydroxyethyl acrylate, 3-hydroxypropyl acrylate, 2-hydroxypropyl acrylate, 4-hydroxybutyl acrylate, 5-hydroxypentyl acrylate, allyl acrylate, 2-allyloxyethyl acrylate, and propargyl acrylate),

methacrylic acid esters such as alkyl methacrylates (the alkyl group preferably having 1 to 20 carbon atoms) (e.g. benzyl methacrylate, 4-biphenyl methacrylate, butyl methacrylate, sec-butyl methacrylate, t-butyl methacrylate, 4-t-butylphenyl methacrylate, 4-chlorophenyl methacrylate, pentachlorophenyl methacrylate, 4-cyanophenyl methacrylate, cyanomethyl methacrylate, cyclohexyl methacrylate, 2-ethoxyethyl methacrylate, ethyl methacrylate, 2-ethylhexyl methacrylate, heptyl methacrylate, hexyl methacrylate, isobornyl methacrylate, isopropyl methacrylate, methyl methacrylate, 3,5-dimethyladamantyl methacrylate, 2-naphthyl methacrylate, neopentyl methacrylate, octyl methacrylate, phenethyl methacrylate, phenyl methacrylate, propyl methacrylate, tolyl methacrylate, amyl methacrylate, tetrahydrofurfuryl methacrylate, 2-hydroxyethyl methacrylate, 3-hydroxypropyl methacrylate, 2-hydroxypropyl methacrylate, 4-hydroxybutyl methacrylate, 5-hydroxypentyl methacrylate, allyl methacrylate, 2-allyloxyethyl methacrylate, propargyl methacrylate, etc.),
acrylamides such as acrylamide and N-alkylacrylamides (e.g. N-methylacrylamide, N-ethylacrylamide, N-propylacrylamide, N-isopropylacrylamide, morpholylacrylamide, piperidylacrylamide, N-butylacrylamide, N-sec-butylacrylamide, N-t-butylacrylamide, N-hexylacrylamide, N-cyclohexylacrylamide, N-phenylacrylamide, N-naphthylacrylamide, N-hydroxymethylacrylamide, N-hydroxyethylacrylamide, N-allylacrylamide, N-propargylacrylamide, 4-hydroxyphenylacrylamide, 2-hydroxyphenylacrylamide, N,N-dimethylacrylamide, N,N-diethylacrylamide, N,N-dipropylacrylamide, N,N-diisopropylacrylamide, N,N-dibutylacrylamide, N,N-di-sec-butylacrylamide, N,N-di-t-butylacrylamide, N,N-dihexylacrylamide, N,N-dicyclohexylacrylamide, N,N-diphenylacrylamide, N,N-dihydroxyethylacrylamide, N,N-diallylacrylamide, N,N-dipropargylacrylamide, etc.),
methacrylamides such as methacrylamide and N-alkylmethacrylamides (e.g. N-methylmethacrylamide, N-ethylmethacrylamide, N-propylmethacrylamide, N-isopropylmethacrylamide, morpholylmethacrylamide, piperidylmethacrylamide, N-butylmethacrylamide, N-sec-butylmethacrylamide, N-t-butylmethacrylamide, N-hexylmethacrylamide, N-cyclohexylmethacrylamide, N-phenylmethacrylamide, N-naphthylmethacrylamide, N-hydroxymethylmethacrylamide, N-hydroxyethylmethacrylamide, N-allylmethacrylamide, N-propargylmethacrylamide, 4-hydroxyphenylmethacrylamide, 2-hydroxyphenylmethacrylamide, N,N-dimethylmethacrylamide, N,N-diethylmethacrylamide, N,N-dipropylmethacrylamide, N,N-diisopropylmethacrylamide, N,N-dibutylmethacrylamide, N,N-di-sec-butylmethacrylamide, N,N-di-t-butylmethacrylamide, N,N-dihexylmethacrylamide, N,N-dicyclohexylmethacrylamide, N,N-diphenylmethacrylamide, N,N-dihydroxyethylmethacrylamide, N,N-diallylmethacrylamide, N,N-dipropargylmethacrylamide, etc.),
styrenes such as styrene and alkylstyrenes (e.g. methylstyrene, dimethylstyrene, trimethylstyrene, ethylstyrene, diethylstyrene, isopropylstyrene, butylstyrene, hexylstyrene, cyclohexylstyrene, decylstyrene, benzylstyrene, chloromethylstyrene, trifluoromethylstyrene, ethoxymethylstyrene, acetoxymethylstyrene, etc.), alkoxystyrenes (e.g. methoxystyrene, 4-methoxy-3-methylstyrene, dimethoxystyrene, etc.), and halostyrenes (e.g. chlorostyrene, dichlorostyrene, trichlorostyrene, tetrachlorostyrene, pentachlorostyrene, bromostyrene, dibromostyrene, iodostyrene, fluorostyrene, trifluorostyrene, 2-bromo-4-trifluoromethylstyrene, 4-fluoro-3-trifluoromethylstyrene, etc.), acrylonitrile, and methacrylonitrile.

Among these polymerizable monomer units, methacrylic acid esters, acrylamides, methacrylamides, and styrenes are suitably used, and in particular benzyl methacrylate, t-butyl methacrylate, 4-t-butylphenyl methacrylate, pentachlorophenyl methacrylate, 4-cyanophenyl methacrylate, cyclohexyl methacrylate, ethyl methacrylate, 2-ethylhexyl methacrylate, isobornyl methacrylate, isopropyl methacrylate, methyl methacrylate, 3,5-dimethyladamantyl methacrylate, 2-naphthyl methacrylate, neopentyl methacrylate, phenyl methacrylate, tetrahydrofurfuryl methacrylate, 2-hydroxyethyl methacrylate, 3-hydroxypropyl methacrylate, 2-hydroxypropyl methacrylate, allyl methacrylate, acrylamide, N-methylacrylamide, N-isopropylacrylamide, morpholylacrylamide, piperidylacrylamide, N-t-butylacrylamide, N-cyclohexylacrylamide, N-phenylacrylamide, N-naphthylacrylamide, N-hydroxymethylacrylamide, N-hydroxyethylacrylamide, N-allylacrylamide, 4-hydroxyphenylacrylamide, 2-hydroxyphenylacrylamide, N,N-dimethylacrylamide, N,N-diisopropylacrylamide, N,N-di-t-butylacrylamide, N,N-dicyclohexylacrylamide, N,N-diphenylacrylamide, N,N-dihydroxyethylacrylamide, N,N-diallylacrylamide, methacrylamide, N-methylmethacrylamide, N-isopropylmethacrylamide, morpholylmethacrylamide, piperidylmethacrylamide, N-t-butylmethacrylamide, N-cyclohexylmethacrylamide, N-phenylmethacrylamide, N-naphthylmethacrylamide, N-hydroxymethylmethacrylamide, N-hydroxyethylmethacrylamide, N-allylmethacrylamide, 4-hydroxyphenylmethacrylamide, 2-hydroxyphenylmethacrylamide, N,N-dimethylmethacrylamide, N,N-diisopropylmethacrylamide, N,N-di-t-butylmethacrylamide, N,N-dicyclohexylmethacrylamide, N,N-diphenylmethacrylamide, N,N-dihydroxyethylmethacrylamide, N,N-diallylmethacrylamide, styrene, methylstyrene, dimethylstyrene, trimethylstyrene, isopropylstyrene, butylstyrene, cyclohexylstyrene, chloromethylstyrene, trifluoromethylstyrene, ethoxymethylstyrene, acetoxymethylstyrene, methoxystyrene, 4-methoxy-3-methylstyrene, chlorostyrene, dichlorostyrene, trichlorostyrene, tetrachlorostyrene, pentachlorostyrene, bromostyrene, dibromostyrene, iodostyrene, fluorostyrene, trifluorostyrene, 2-bromo-4-trifluoromethylstyrene, 4-fluoro-3-trifluoromethylstyrene, etc. are suitably used.

With regard to these copolymer components, one type or two or more types may be used. When the specific initiator is a copolymer, the content of the copolymer component is preferably 0 to 60 mole %, more preferably 0 to 50 mole %, yet more preferably 0 to 40 mole %, and particularly preferably 0 to 20 mole %. It is preferable for the copolymer component to be no greater than 60 mole % since the reactivity is high and the non-tackiness (suppression of surface tackiness) is excellent. In other words, it is preferable for the photopolymerization initiator residue-containing monomer unit to be 40 to 100 mole %, more preferably 50 to 100 mole %, yet more preferably 60 to 100 mole %, and particularly preferably 80 to 100 mole %.

The specific initiator of the present invention preferably has a weight-average molecular weight Mw of 1,000 to 100,000, more preferably in the range of 3,000 to 70,000, and most preferably in the range of 4,000 to 40,000. It is preferable for the molecular weight to be at least 1,000 since the specific initiator and a decomposition product thereof have low volatility, and an effect in suppressing odor is high. Moreover, it is preferable for the molecular weight to be no greater than 100,000 since the photocurable coating composition has low viscosity and excellent surface smoothness can be obtained.

In the present invention, either an onium type specific initiator or a non-onium type specific initiator may be used, but it is preferable that the photopolymerization initiator residue-containing monomer unit comprises a residue selected from the group consisting of an onium salt, a borate salt, an imide structure-containing compound, a triazine structure-containing compound, an azo compound, a peroxide, a lophine dimer, and a benzoyl compound, it is more preferable that it has a residue selected from the group consisting of an onium salt, a borate salt, an imide structure-containing compound, a triazine structure-containing compound, an azo compound, a peroxide, and a lophine dimer, and it is yet more preferable that it has an onium salt residue. It is preferable to use the above-mentioned specific initiator since the curability is high and there is little production of odor.

Specific examples of the specific initiator related to the present invention are listed below, but the present invention is not limited thereby. Compound examples (I-1) to (IV-7) are sulfonium-based and iodonium-based compounds, and compound examples (N-1) to (N-11) and (N-13) to (N-30) are diazonium-based specific initiators, imide structure-containing specific initiators, azinium-based specific initiators, triazine structure-containing specific initiators, benzoin specific initiators, azo specific initiators, peroxide specific initiators, lophine dimer specific initiators, and borate salt specific initiators.

The figures given for each structural unit denote polymerization molar ratio, and 100 means that it is a homopolymer comprising only the corresponding monomer unit.

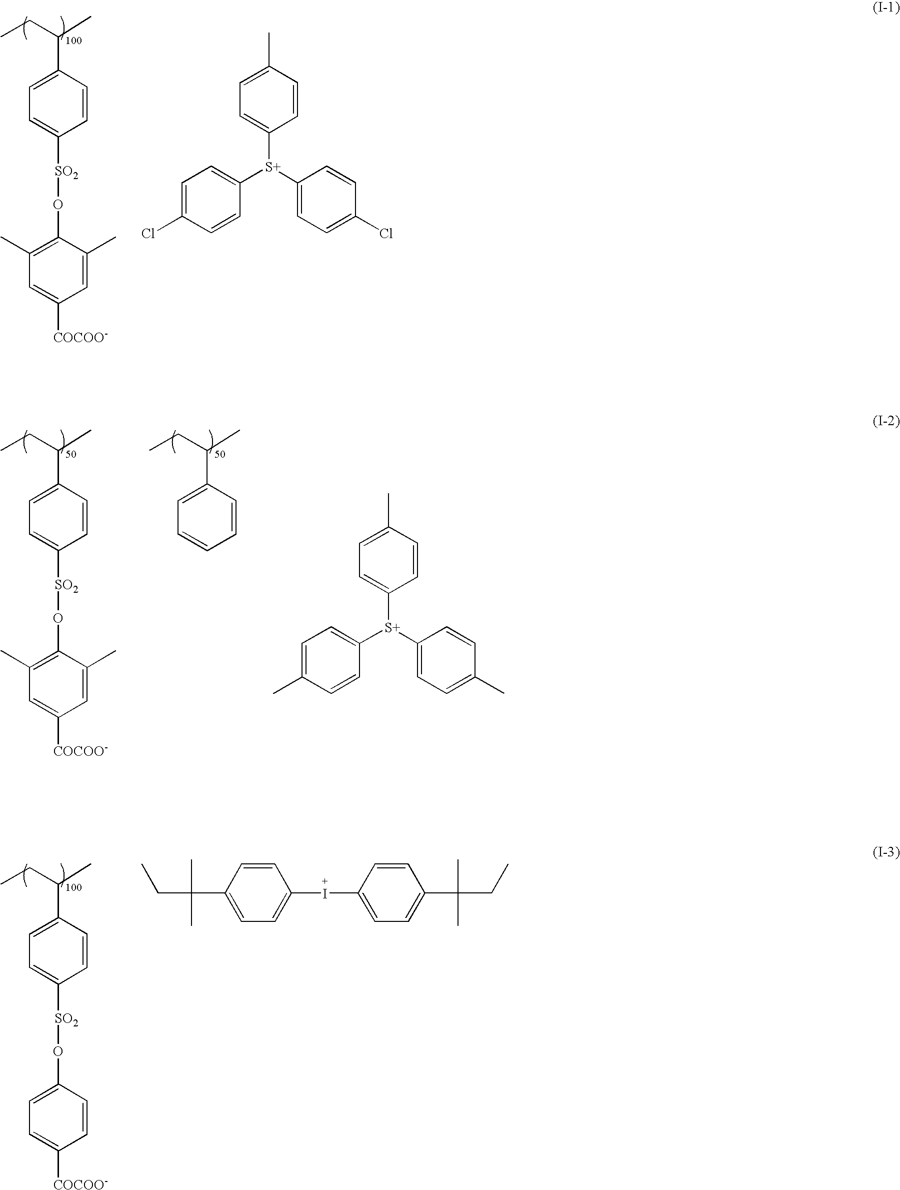

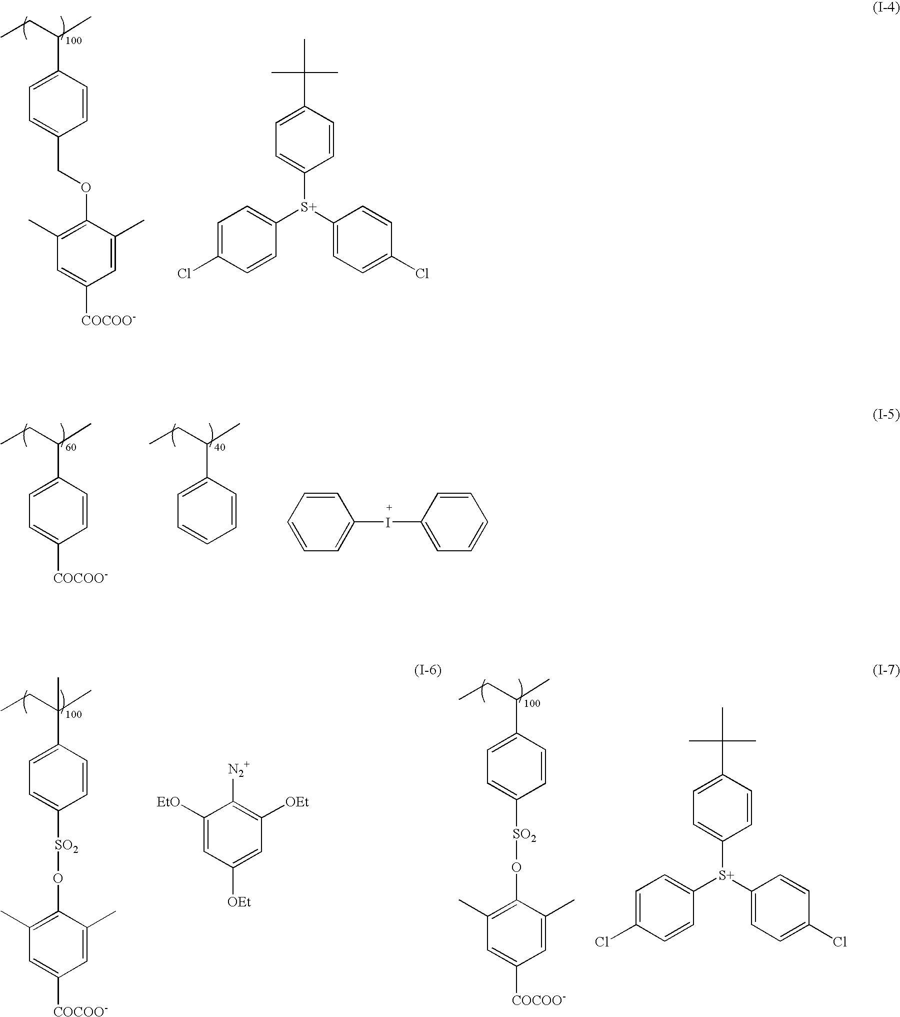

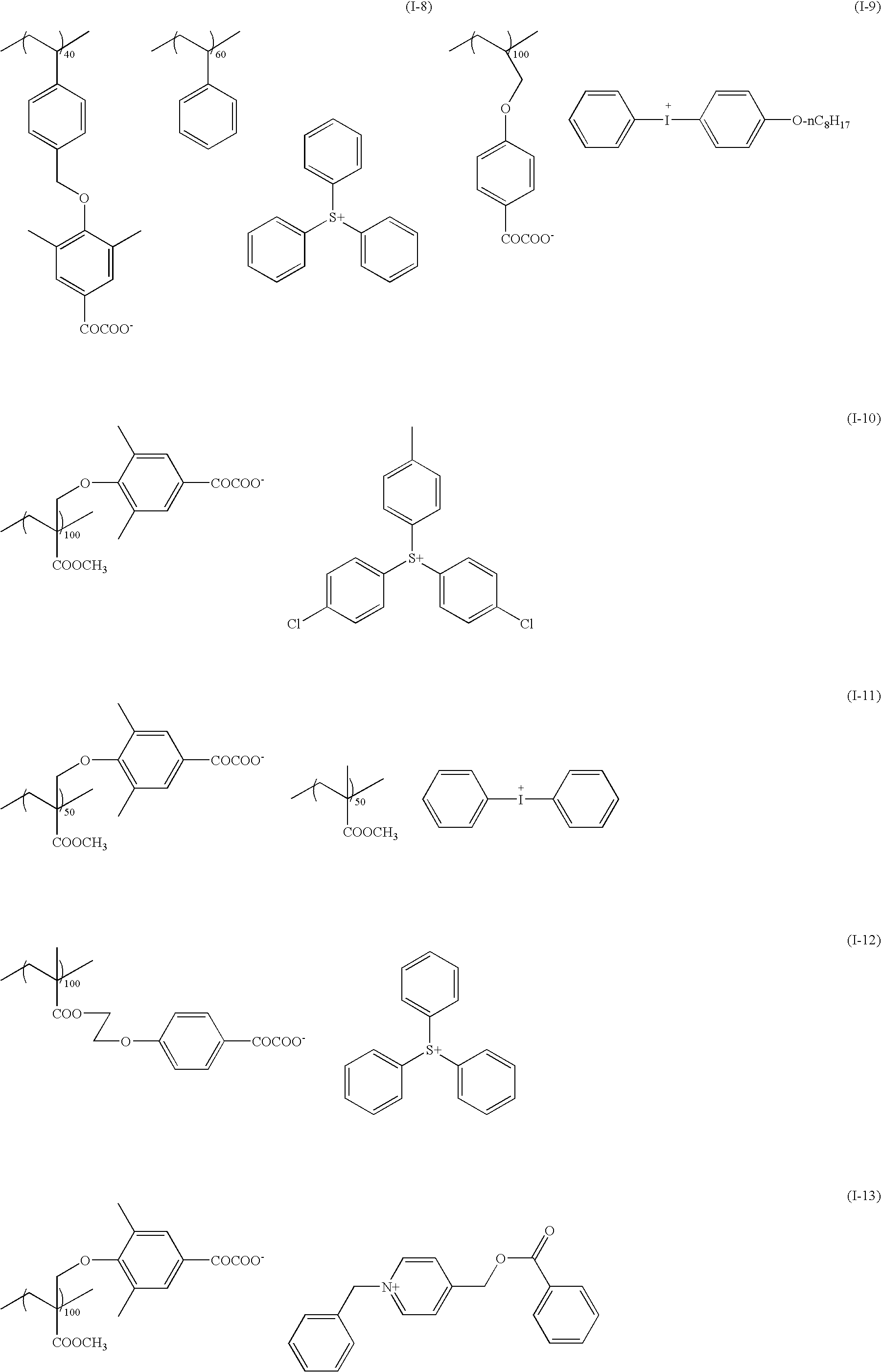

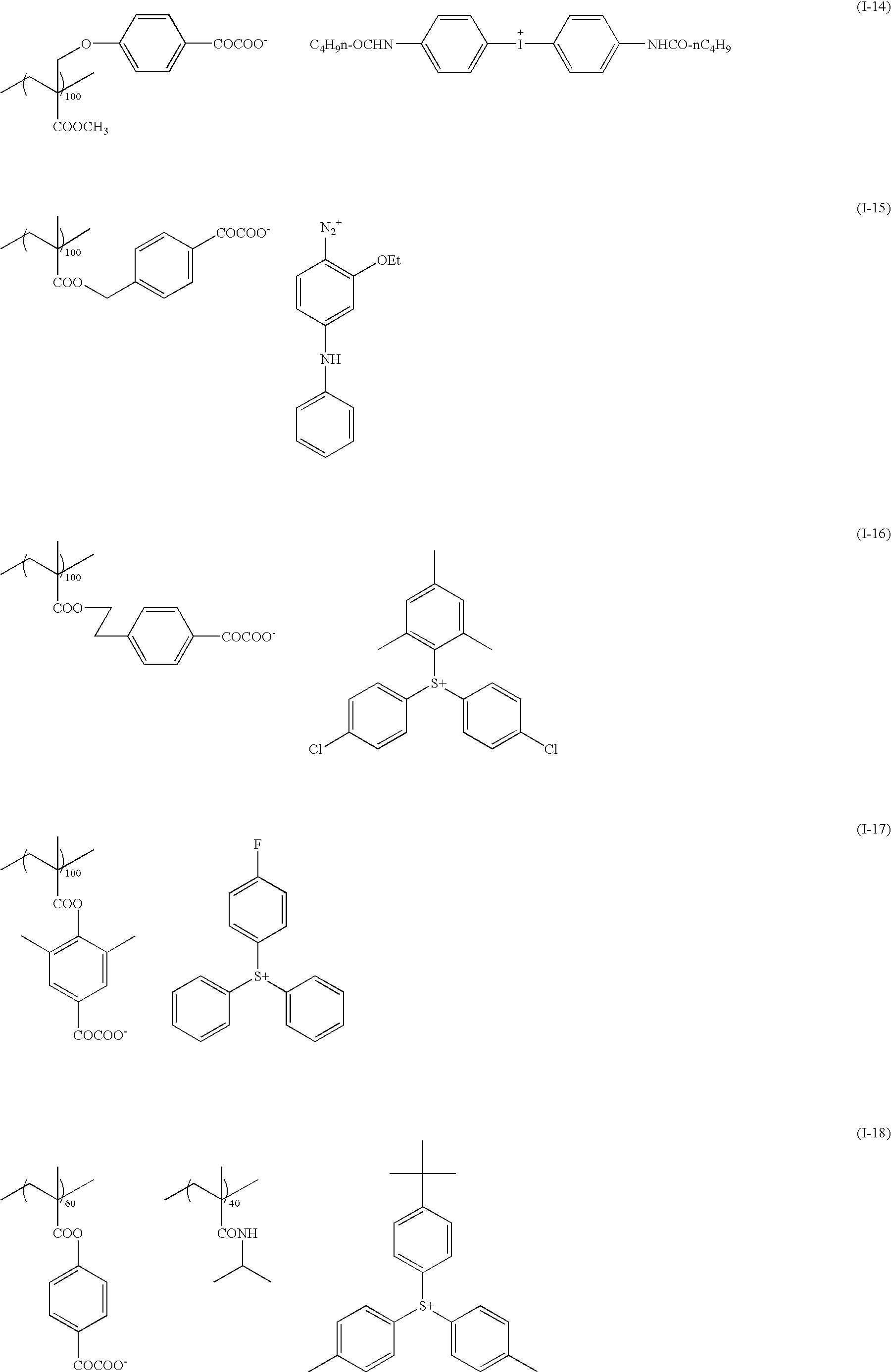

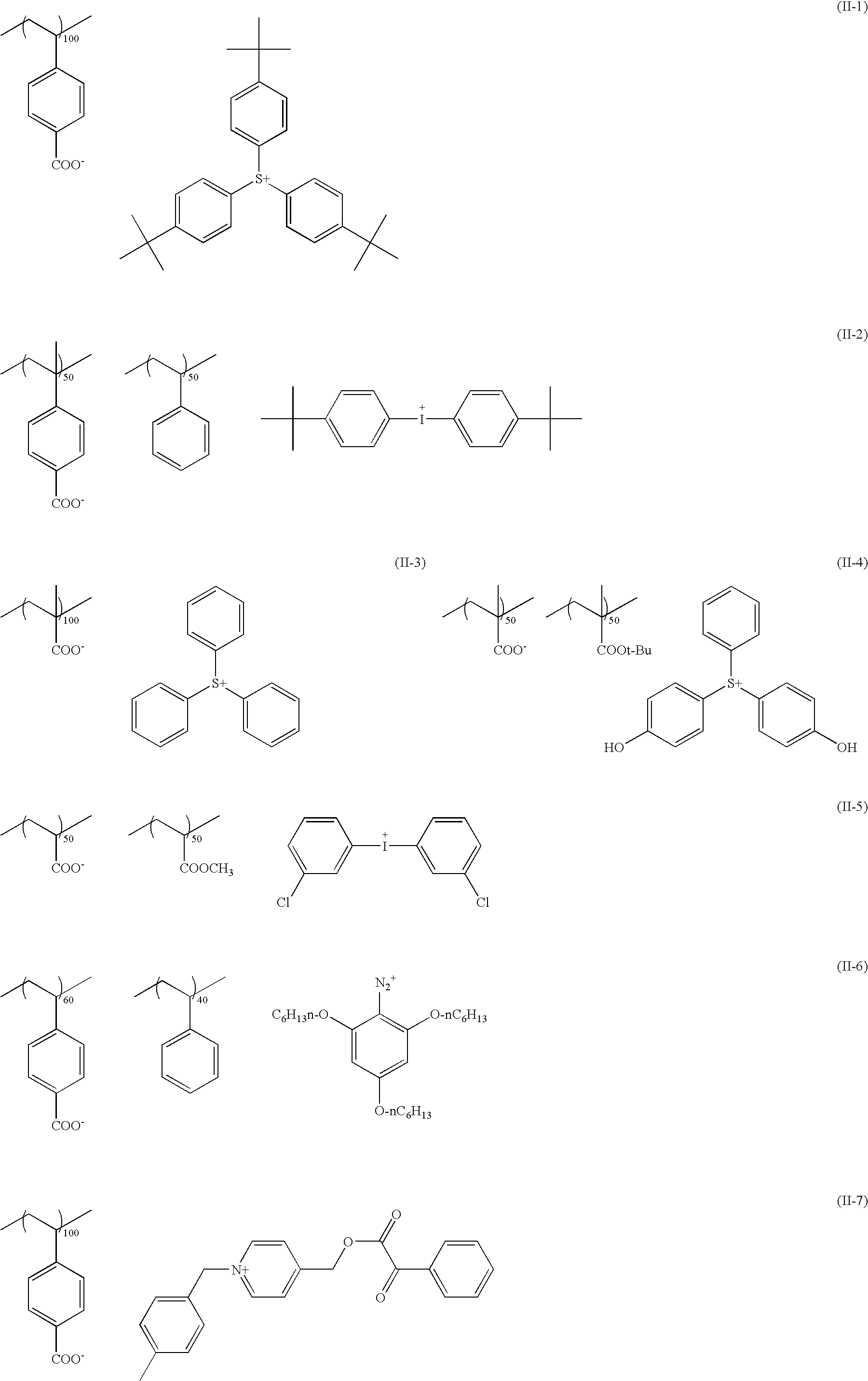

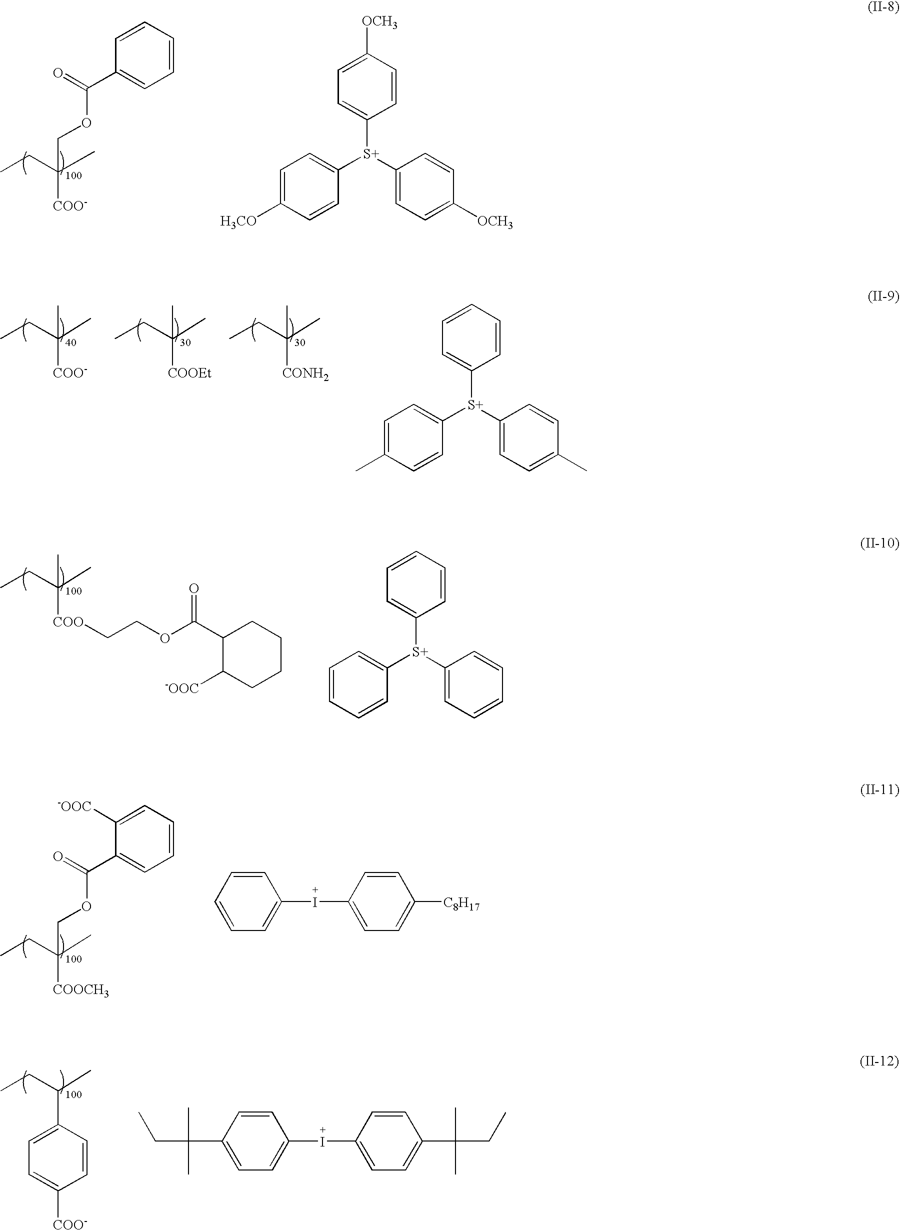

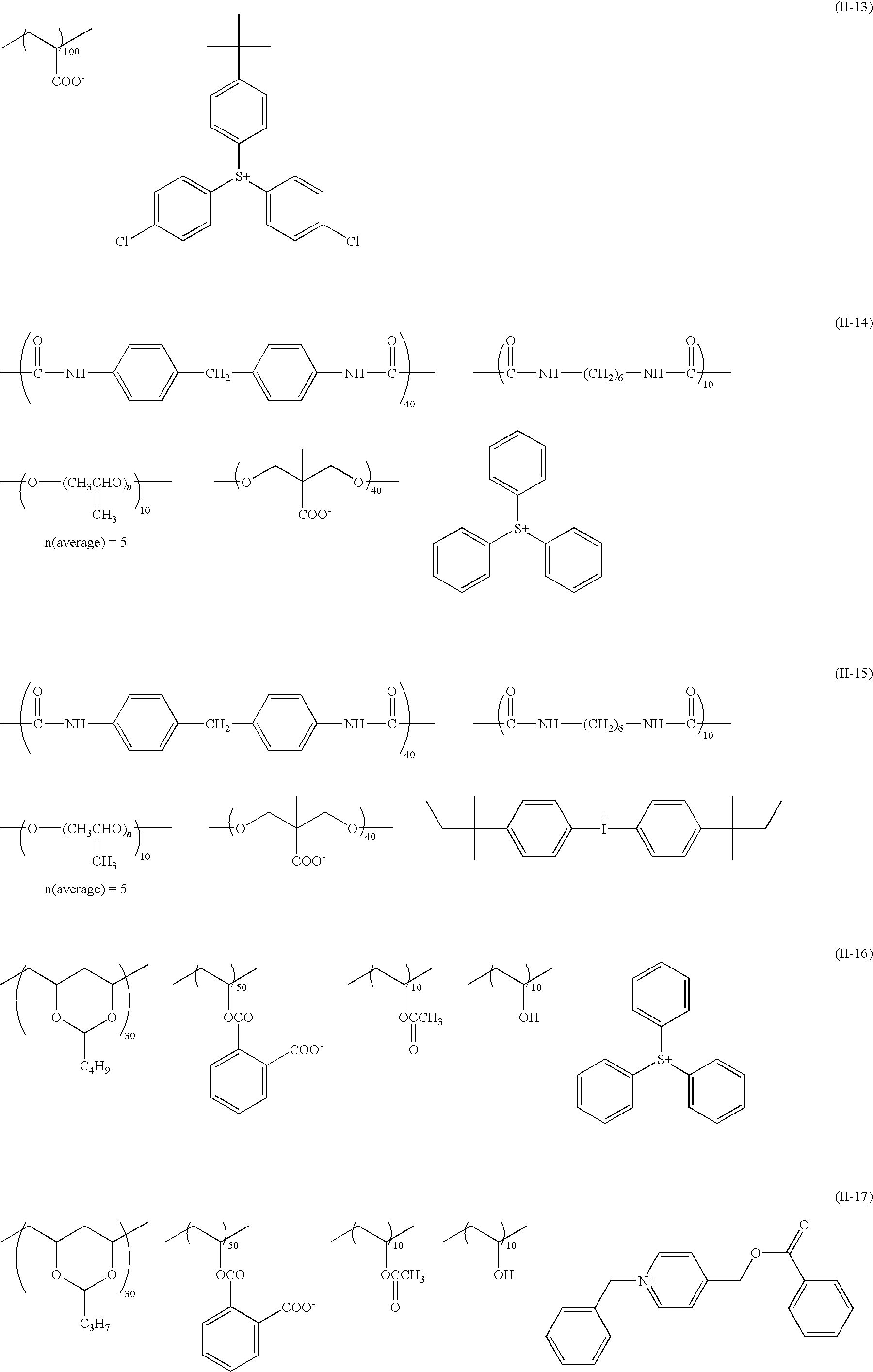

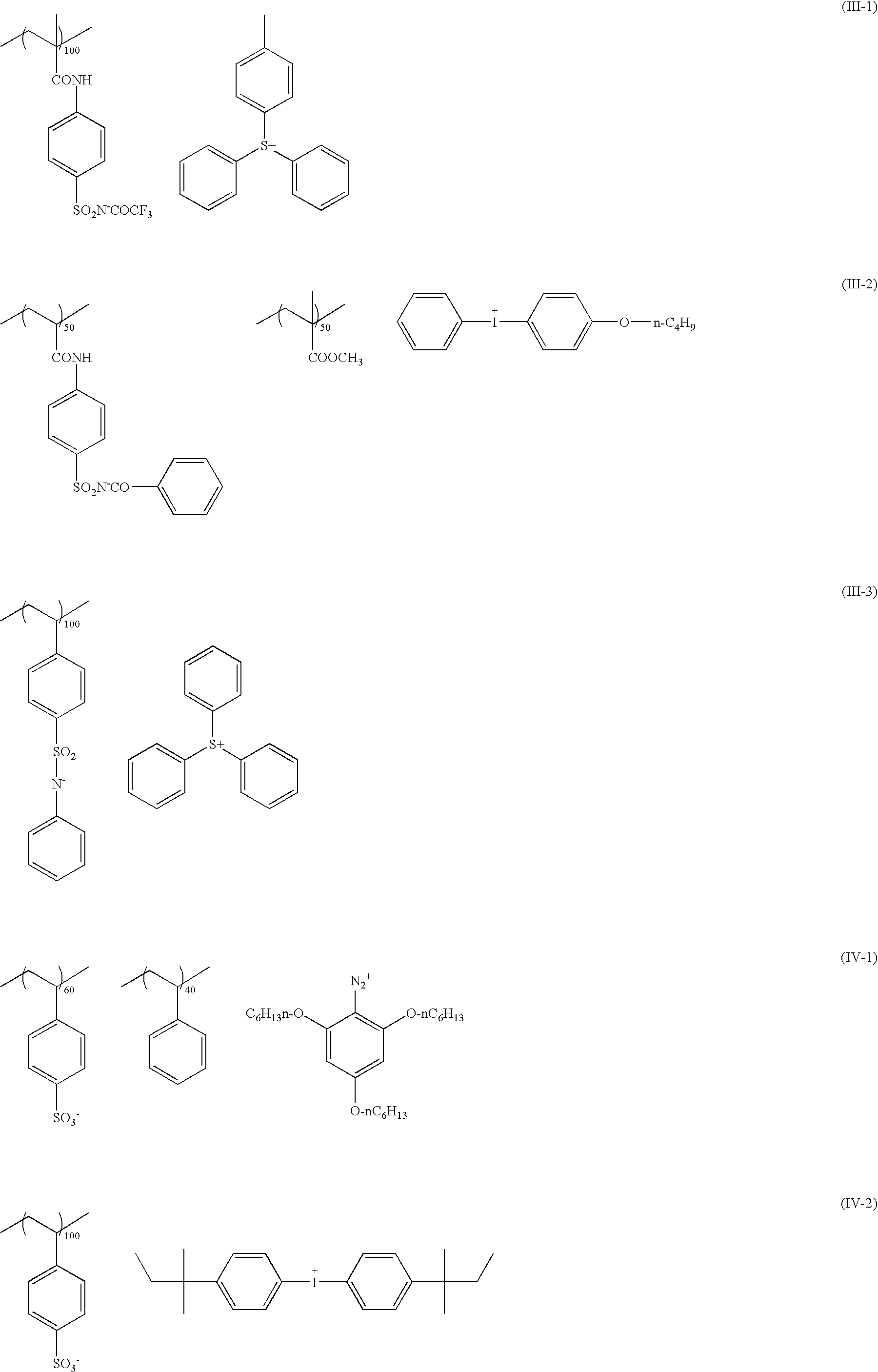

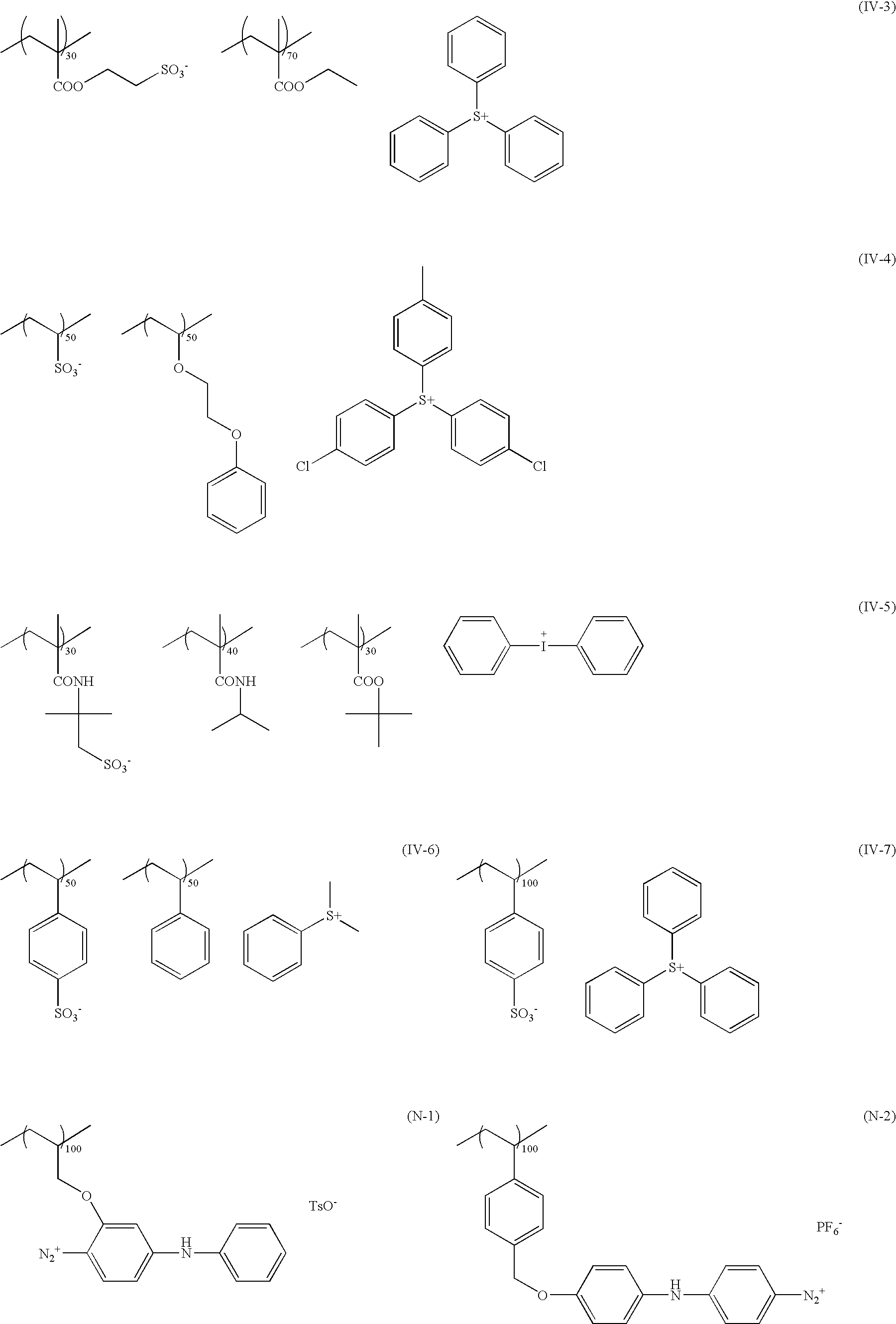

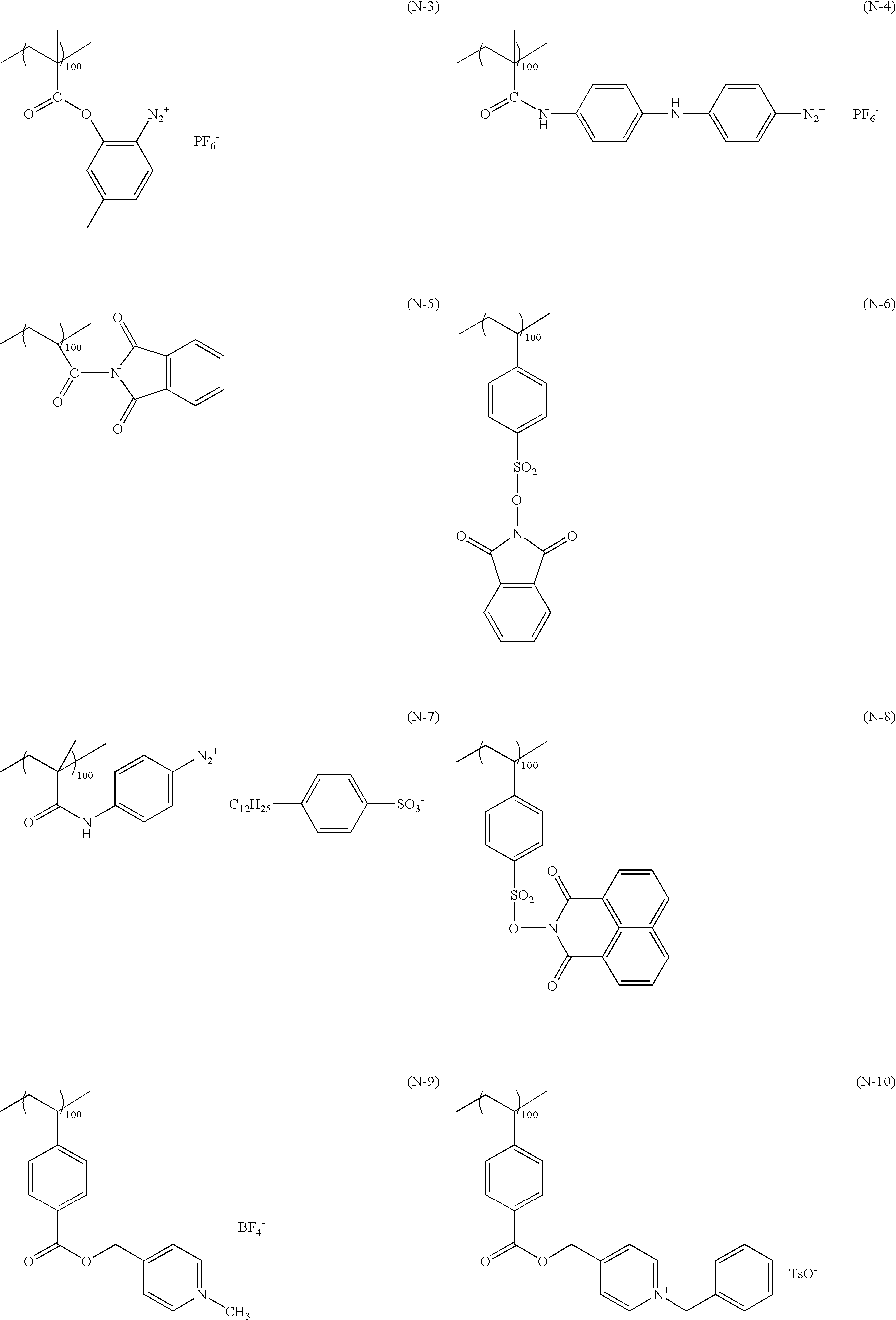

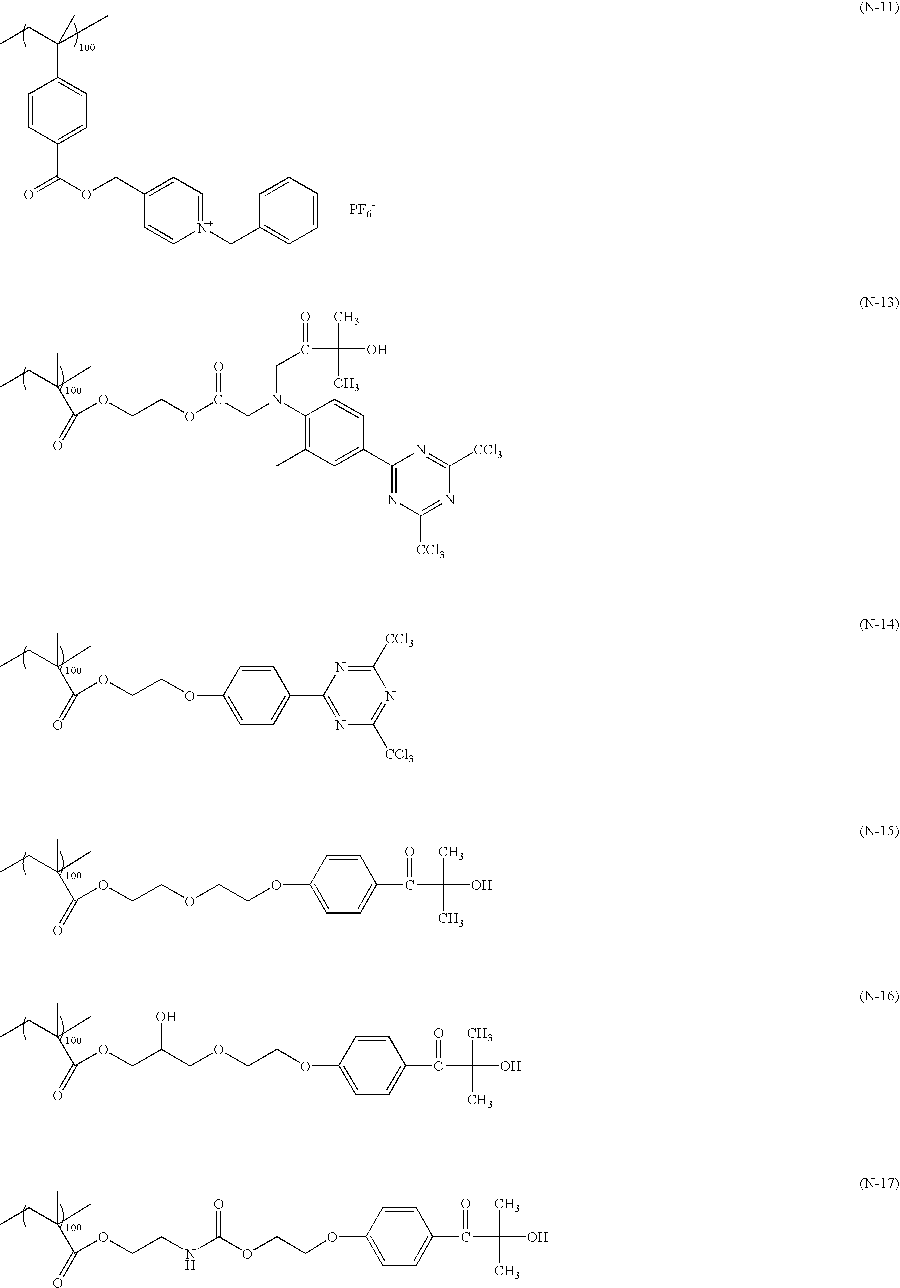

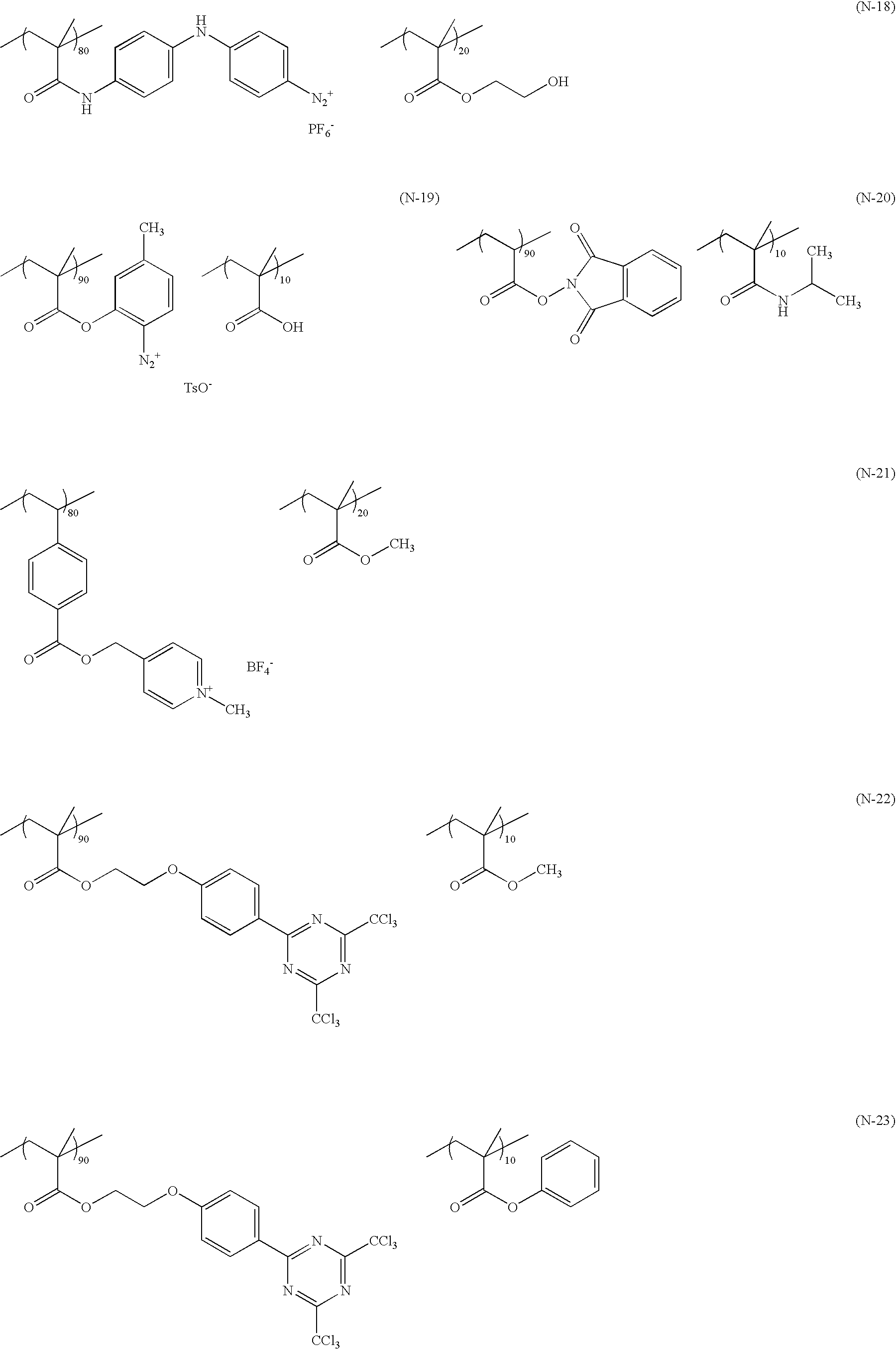

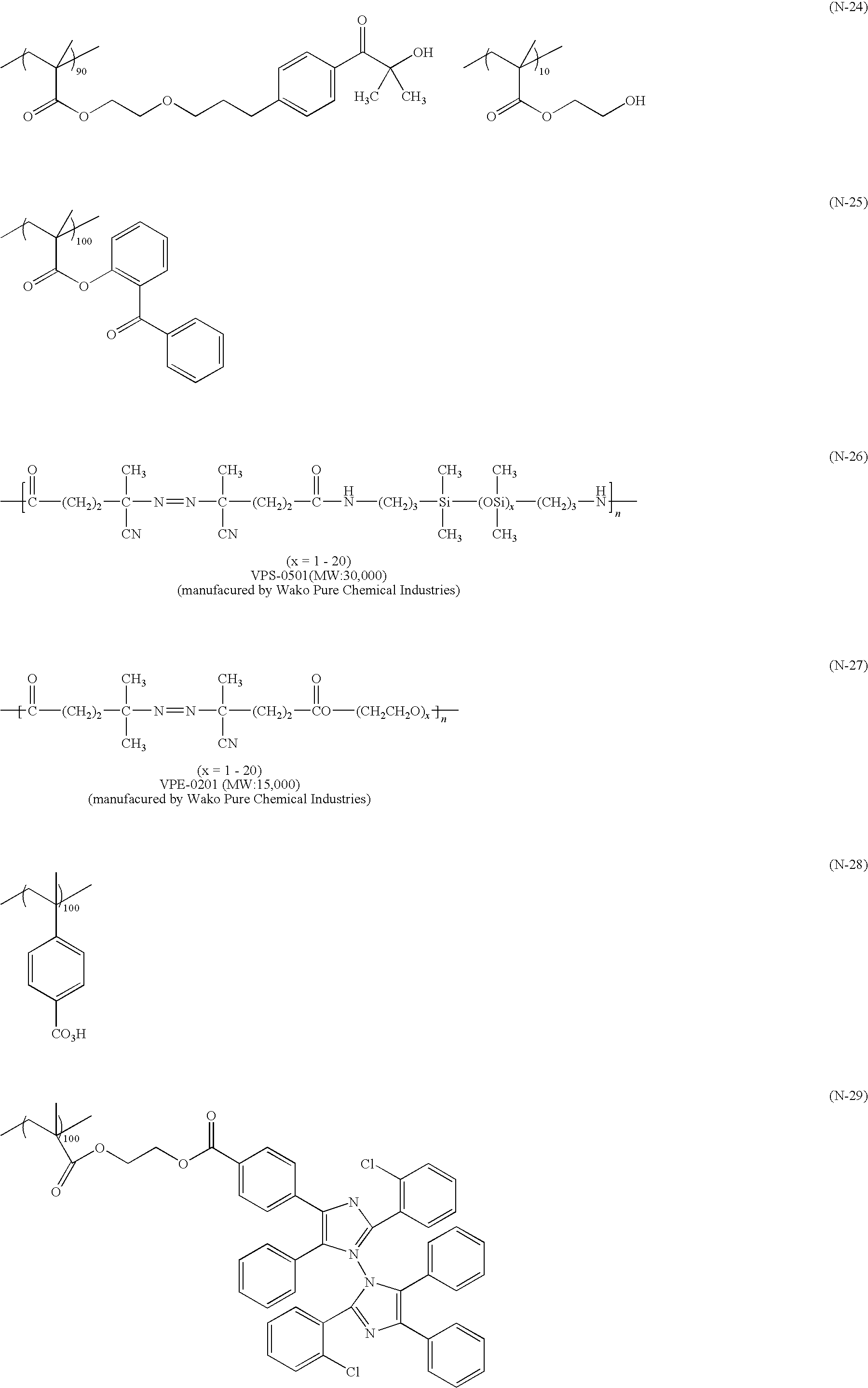

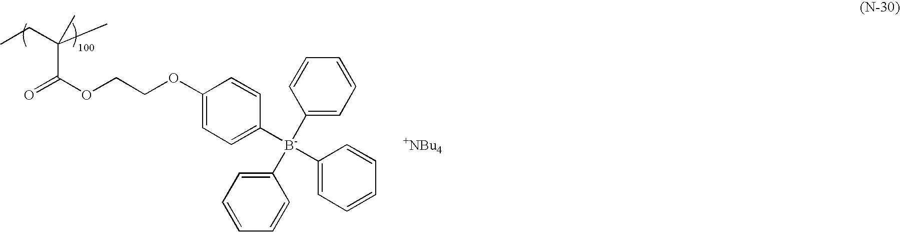

The specific initiator may be readily synthesized by a known method. A synthetic example for specific initiator (I-1) is illustrated below.

### Synthesis of Specific Initiator (I-1)

133 g of aluminum chloride and 350 mL of nitrobenzene were mixed at room temperature and kept at 0° C. to 10° C. After 136.5 g of ethyl chloroformate was added thereto dropwise over 15 minutes at 0° C. to 10° C. and stirring was carried out for 15 minutes, 116.1 g of 2,6-dimethylphenol dissolved in 150 mL of nitrobenzene and kept at 0° C. to 10° C. was added dropwise over 30 minutes. After stirring at 0° C. to 10° C. for 2 hours, stirring was carried out at room temperature for 1 hour. 60 mL of conc. hydrochloric acid was mixed with 2 L of ice water, and the reaction mixture was gently poured thereinto. After extraction with 1,500 mL of ethyl acetate was carried out, the organic layer was dried with sodium sulfate and concentrated, and nitrobenzene was removed by vacuum distillation, thus giving a solid. This solid was reslurried with 300 mL of diisopropyl ether and filtered, thus giving 149 g of solid (A) below (yield: 66.8%).

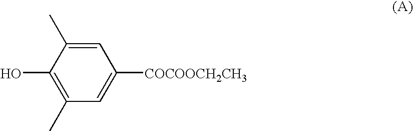

111 g of solid (A) above was dissolved in 80 g of pyridine and cooled to 0° C. to 10° C., and 152 g p-styrenesulfonyl chloride was added dropwise thereto. After the dropwise addition, stirring was carried out at 0° C. to 10° C. for 2 hours and at room temperature for 2 hours, 80 mL of conc. hydrochloric acid was mixed with 2 L of ice water, the reaction mixture was diluted with 150 mL of acetone and gently poured thereinto to thus precipitate a solid, filtration was carried out, and the residue was reslurried with 300 mL of methanol, thus giving 151 g of solid (B) below (yield: 77.5%).

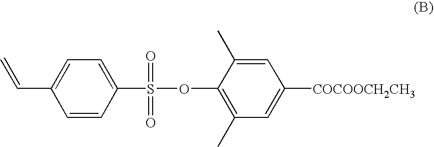

31.07 g of solid (B) above was dissolved in 64 g of methyl ethyl ketone, stirring was carried out under a nitrogen atmosphere at 70° C., 0.64 g of polymerization initiator V-65, manufactured by Wako Pure Chemical Industries, Ltd., was added thereto, stirring was carried out for 2 hours, a further 0.32 g of V-65 was added thereto, stirring was carried out for 2 hours, a further 0.16 g of V-65 was added thereto, and stirring was carried out for 2 hours. After cooling to room temperature, the mixture was poured into 1 kg of a hexane solution containing 5% of 2-propanol, thus giving 27 g of a polymer. 7 g of the polymer was dissolved in 30 mL of DMAc (N,N-dimethylacetamide) and 70 mL of 1-methoxy-2-propanol, an aqueous solution of 1.02 g of potassium hydroxide in 70 mL of water was added dropwise thereto at room temperature, after stirring for 2 hours the mixture was poured into a mixed solution of 500 mL of ice water and 20 mL of conc. hydrochloric acid to thus precipitate a carboxylic acid solid, and the solid was filtered and dried, thus giving COCOOH unit-containing polymer (C).

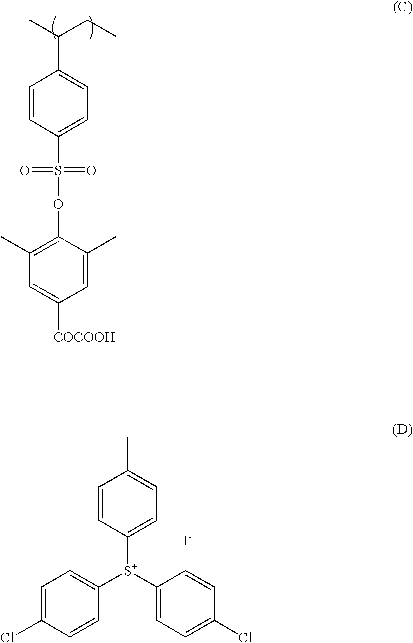

1.42 g of sulfonium salt (D) above was dissolved in 50 mL of methanol,
0.72 g of silver oxide was added thereto, and stirring was carried at room temperature for 4 hours. After stirring, the mixture was filtered, the filtrate was further filtered using a 0.1 μm filter, a solution of polymer (C) above in 50 mL of acetone and 10 mL of methanol was added dropwise to the filtrate, and after the dropwise addition it was concentrated to thus precipitate a semi-solid. The semi-solid was washed with ethyl acetate and diisopropyl ether, thus giving specific initiator (I-1). When the molecular weight of specific initiator (I-1) above was measured using a TSK-GEL α column, manufactured by Tosoh Corporation, it was found that Mw=6,300.

Various types of specific initiators may be synthesized by the same method as above or using a known acid group-containing polymer.

### Synthetic Example of Non-Onium Type Specific Initiator (N-14)

A 1-methoxy-2-propanol (300 g) solution of polymerizable monomer (1) below (0.2 mol) and 2,2′-azobis(2-methylbutyronitrile) (Wako Pure Chemical Industries, Ltd.) (0.01 mol) was added dropwise to 1-methoxy-2-propanol (300 g) at 50° C. under a flow of nitrogen over 6 hours. After the dropwise addition was complete, stirring was carried out at 50° C. for a further 18 hours, thus giving compound N-14 of the present invention. The structure of polymer (P-1) obtained was identified by NMR.

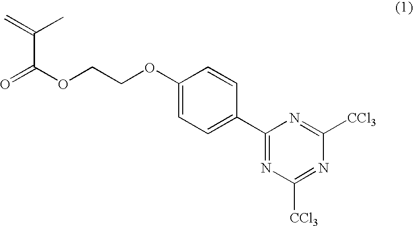

In the present invention, with regard to these specific initiators, one type thereof may be used on its own or two or more types may be used in combination.

The content of the specific initiator contained in the total solids of the photocurable coating composition of the present invention is preferably 1 to 40 wt %, more preferably 5 to 35 wt %, and most preferably 5 to 30 wt %. It is preferable for the amount thereof added to be at least 1 wt % since the sensitivity is excellent and the non-tackiness (surface tackiness) improves. Furthermore, it is preferable for it to be no greater than 40 wt % since the viscosity is appropriate and good surface smoothness can be obtained.

The total solids of the photocurable coating composition referred to means the total components of the photocurable coating composition, excluding solvent.

The photocurable coating composition of the present invention may comprise as necessary a known polymerization initiator such as a triazine compound, a borate compound, an azo compound, a peroxide, a lophine dimer, or an acylphosphine compound in a range that does not interfere with the effects of the present invention. These compounds may be added in the range of 0 to 30 wt % of the total amount of initiators including the specific initiator contained in the photocurable coating composition, and preferably in the range of 0 to 10 wt %.

Specific initiator (A) used in the present invention preferably has a maximum absorption wavelength of no greater than 400 nm, and more preferably no greater than 360 nm. By setting the absorption wavelength in the UV region in this way a coating composition having high transparency can be obtained.

### (B) Polymerizable Compound

The coating composition of the present invention comprises (B) a polymerizable compound.

As the polymerizable compound, a radically polymerizable compound may be used or a cationically polymerizable compound may be used.

### Radically Polymerizable Compound

In the present invention, as the radically polymerizable compound, an ethylenically unsaturated bond-containing compound is preferable.

The radically polymerizable compound in the present invention may be any compound as long as it has at least one ethylenically unsaturated bond, and those having a chemical form such as monomer, oligomer, or polymer are included.

With regard to the radically polymerizable compound, one type thereof may be used on its own, or two or more types thereof may be used in combination at any ratio in order to improve intended properties. From the viewpoint of controlling performance such as reactivity and physical properties, it is preferable to use two or more types of radically polymerizable compounds in combination.

Examples of the radically polymerizable compound include unsaturated carboxylic acids such as acrylic acid, methacrylic acid, itaconic acid, crotonic acid, isocrotonic acid, and maleic acid, and salts thereof, anhydrides having an ethylenically unsaturated bond, acrylonitrile, styrene, various types of unsaturated polyesters, unsaturated polyethers, unsaturated polyamides, and unsaturated urethanes.

Specific examples thereof include acrylic acid derivatives such as methyl acrylate, ethyl acrylate, n-butyl acrylate, 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxypolyethoxyphenyl)propane, neopentyl glycol diacrylate, 1,6-hexanediol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, oligoester acrylate, N-methylolacrylamide, diacetoneacrylamide, and epoxyacrylate, methacrylic derivatives such as methyl methacrylate, ethyl methacrylate, n-butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, ethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, and 2,2-bis(4-methacryloxypolyethoxyphenyl)propane, N-vinyl compounds such as N-vinylpyrrolidone and N-vinylcaprolactam, allyl compound derivatives such as allyl glycidyl ether, diallyl phthalate, and triallyl trimellitate and, more specifically, radically polymerizable or crosslinking monomers, oligomers, and polymers that are commercial products or are industrially known, such as those described in ‘Kakyozai Handobukku’ (Crosslinking Agent Handbook), Ed. S. Yamashita (Taiseisha, 1981); ‘UV.EB Koka Handobukku’ (UV.EB Curing Handbook) (Starting Materials) Ed. K. Kato (Kobunshi Kankoukai, 1985); ‘UV.EB Koka Gijutsu no Oyo to Shijyo’ (Application and Market of UV.EB Curing Technology), p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) may be used.

Furthermore, as the radically polymerizable compound, photocuring polymerizable compound materials used in photopolymerizable compositions described in, for example, JP-A-7-159983, JP-B-7-31399, JP-A-8-224982, JP-A-10-863, JP-A-9-134011, etc. are known, and they may be used in the coating composition of the present invention.

Moreover, as the radically polymerizable compound, a vinyl ether compound is also preferably used. Examples of vinyl ether compounds that can suitably be used include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether, dodecyl vinyl ether, diethylene glycol monovinyl ether, ethylene glycol monovinyl ether, triethylene glycol monovinyl ether, hydroxyethyl monovinyl ether, and hydroxynonyl monovinyl ether.

Among these vinyl ether compounds, divinyl ether compounds and trivinyl ether compounds are preferable from the viewpoint of curability, adhesion, and surface hardness, and divinyl ether compounds are particularly preferable. With regard to the vinyl ether compound, one type thereof may be used on its own or two or more types may be used in an appropriate combination.

As other polymerizable compounds that can be used in the present invention, (meth)acrylic acid esters such as (meth)acrylic-based monomers or prepolymers, epoxy-based monomers or prepolymers, or urethane-based monomers or prepolymers (hereinafter, also called ‘acrylate compounds’ as appropriate) are preferably used. Preferred specific examples thereof are as follows.

That is, there can be cited 2-ethylhexyldiglycol acrylate, 2-hydroxy-3-phenoxypropyl acrylate, 2-hydroxybutyl acrylate, hydroxypivalic acid neopentyl glycol diacrylate, 2-acryloyloxyethylphthalic acid, methoxy polyethylene glycol acrylate, tetramethylolmethane triacrylate, 2-acryloyloxyethyl-2-hydroxyethylphthalic acid, dimethyloltricyclodecane diacrylate, ethoxylated phenyl acrylate, 2-acryloyloxyethylsuccinic acid, nonylphenol ethylene oxide (EO) adduct acrylate, modified glycerol triacrylate, bisphenol A diglycidyl ether acrylic acid adduct, modified bisphenol A diacrylate, phenoxypolyethylene glycol acrylate, 2-acryloyloxyethylhexahydrophthalic acid, bisphenol A propylene oxide (PO) adduct diacrylate, bisphenol A EO adduct diacrylate, dipentaerythritol hexaacrylate, pentaerythritol triacrylate tolylenediisocyanate urethane prepolymer, lactone-modified flexible acrylate, butoxyethyl acrylate, propylene glycol diglycidyl ether acrylic acid adduct, pentaerythritol triacrylate hexamethylenediisocyanate urethane prepolymer, 2-hydroxyethyl acrylate, methoxydipropylene glycol acrylate, ditrimethylolpropane tetraacrylate, pentaerythritol triacrylate hexamethylenediisocyanate urethane prepolymer, stearyl acrylate, isoamyl acrylate, isomyristyl acrylate, isostearyl acrylate, lactone-modified acrylate, and corresponding methacrylate compounds etc.

The monomers listed above have high reactivity, low viscosity, and excellent adhesion to a recording medium.

In the present invention, in order to improve the non-tackiness (suppression of surface tackiness) and surface smoothness, to improve transparency more, it is preferable to use the compound in above-mentioned as the radically polymerizable compound among the compounds described above, a polyfunctional acrylate compound.

As polyfunctional acrylate compounds that can be used in the present invention, bisphenol A epoxydiacrylate and tripropileneglycoldiacrylate are particularly preferable.

When a polyfunctional ethylenically unsaturated compound is used, the content of the polyfunctional ethylenically unsaturated compound, relative to the total weight of the coating composition, is preferably 5 to 80 wt %, and more preferably 40 to 70 wt %. When the content is in the above-mentioned range, the non-tackiness is excellent.

In addition, in the present invention, depending on the various kinds of purposes, a combination of a radically polymerizable compound and a radical polymerization initiator, a combination of a cationically polymerizable compound and a cationic polymerization initiator, or a radical/cationic hybrid type coating composition combining the polymerizable compounds and polymerization initiators may be employed.

### Cationically Polymerizable Compound

The cationically polymerizable compound in the present invention is not particularly limited as long as it is a compound that undergoes a cationic polymerization reaction and cures as a result of the application of energy in any way; any type of monomer, oligomer, or polymer may be used, and in particular various types of known cationically polymerizable monomers known as cationic photopolymerizable monomers, in which a polymerization reaction is caused by an initiating species generated from the above-mentioned cationic polymerization initiator, may be used. Furthermore, the cationically polymerizable compound may be a monofunctional compound or a polyfunctional compound.

As the cationically polymerizable compound in the present invention, from the viewpoint of curability and abrasion resistance, an oxetane ring-containing compound and an oxirane ring-containing compound are preferable, and a mode in which both an oxetane ring-containing compound and an oxirane ring-containing compound are contained is more preferable.

In the present specification, the oxirane ring-containing compound (hereinafter, also called an ‘oxirane compound’ as appropriate in some cases) is a compound containing at least one oxirane ring (oxiranyl group, epoxy group) in the molecule; specifically, it may be selected as appropriate from those usually used as epoxy resins, and examples thereof include conventionally known aromatic epoxy resins, alicyclic epoxy resins, and aliphatic epoxy resins. It may be any of monomer, oligomer, and polymer. Furthermore, the oxetane ring-containing compound (hereinafter, also called an ‘oxetane compound’ as appropriate in some cases) is a compound containing at least one oxetane ring (oxetanyl group) in the molecule.

The cationically polymerizable compound that can be used in the present invention is explained in detail below.

Examples of the cationically polymerizable monomer include epoxy compounds, vinyl ether compounds, and oxetane compounds described in JP-A-6-9714, JP-A-2001-31892, JP-A-2001-40068, JP-A-2001-55507, JP-A-2001-310938, JP-A-2001-310937, JP-A-2001-220526, etc.

Examples of monofunctional epoxy compounds used in the present invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexanecarboxylate, 2-(3,4-epoxycyclohexyl-5,5-spiro-3,4-epoxy)cyclohexane-meta-dioxane, bis(3,4-epoxycyclohexylmethyl) adipate, vinylcyclohexene dioxide, 4-vinylepoxycyclohexane, bis(3,4-epoxy-6-methylcyclohexylmethyl) adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl)ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Among these epoxy compounds, the aromatic epoxides and the alicyclic epoxides are preferable from the viewpoint of excellent curing speed, and the alicyclic epoxides are particularly preferable.

Specific examples of monofunctional vinyl ethers include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of polyfunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, and a propylene oxide adduct of dipentaerythritol hexavinyl ether.

As the vinyl ether compound, the di- or tri-vinyl ether compounds are preferable from the viewpoint of curability, adhesion to a recording medium, surface hardness of the image formed, etc., and the divinyl ether compounds are particularly preferable.

The oxetane compound in the present invention may be selected freely from known oxetane compounds such as those described in JP-A-2001-220526, JP-A-2001-310937, and JP-A-2003-341217.

As the compound having an oxetane ring that can be used in the photocurable coating composition of the present invention, a compound having 1 to 4 oxetane rings in the structure is preferable. In accordance with use of such a compound, it becomes easy to maintain the viscosity of the coating composition in a range that gives good handling properties and, furthermore, after cured it can be given high adhesion to the printed material, which is preferable.

Examples of monofunctional oxetane compounds used in the present invention include 3-ethyl-3-hydroxymethyloxetane, 3-allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl (3-ethyl-3-oxetanylmethyl)ether, isobornyloxyethyl (3-ethyl-3-oxetanylmethyl)ether, isobornyl (3-ethyl-3-oxetanylmethyl)ether, 2-ethylhexyl (3-ethyl-3-oxetanylmethyl)ether, ethyl diethylene glycol (3-ethyl-3-oxetanylmethyl)ether, dicyclopentadiene (3-ethyl-3-oxetanylmethyl)ether, dicyclopentenyloxyethyl (3-ethyl-3-oxetanylmethyl)ether, dicyclopentenyl (3-ethyl-3-oxetanylmethyl)ether, tetrahydrofurfuryl (3-ethyl-3-oxetanylmethyl)ether, tetrabromophenyl (3-ethyl-3-oxetanylmethyl)ether, 2-tetrabromophenoxyethyl (3-ethyl-3-oxetanylmethyl)ether, tribromophenyl (3-ethyl-3-oxetanylmethyl)ether, 2-tribromophenoxyethyl (3-ethyl-3-oxetanylmethyl)ether, 2-hydroxyethyl (3-ethyl-3-oxetanylmethyl)ether, 2-hydroxypropyl (3-ethyl-3-oxetanylmethyl)ether, butoxyethyl (3-ethyl-3-oxetanylmethyl)ether, pentachlorophenyl (3-ethyl-3-oxetanylmethyl)ether, pentabromophenyl (3-ethyl-3-oxetanylmethyl)ether, and bornyl (3-ethyl-3-oxetanylmethyl)ether.

Examples of polyfunctional oxetane compounds include 3,7-bis(3-oxetanyl)-5-oxanonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenylbis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene (3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, ethylene oxide (EO)-modified bisphenol A bis(3-ethyl-3-oxetanylmethyl)ether, propylene oxide (PO)-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, and EO-modified bisphenol F (3-ethyl-3-oxetanylmethyl)ether.

Such oxetane compounds are described in detail in Paragraph Nos. 0021 to 0084 of JP-A-2003-341217, and compounds described therein can be used suitably in the present invention.

Among the oxetane compounds used in the present invention, it is preferable to use a compound having 1 to 2 oxetane rings.

In the present invention, with regard to these cationically polymerizable compounds, one type may be used on its own, or two or more types may be used in combination.

From the viewpoint of curability and surface smoothness, the content of polymerizable compound (B) in the photocurable coating composition of the present invention, relative to the total weight of the coating composition, is preferably in the range of 10 to 97 wt %, more preferably in the range of 30 to 95 wt %, and particularly preferably in the range of 50 to 90 wt %.

Furthermore, with regard to polymerizable compound (B), one type thereof may be used, or two or more types may be used in combination.

### Sensitizer

The coating composition of the present invention may comprise a sensitizer for promoting decomposition of the photopolymerization initiator by irradiation with actinic radiation.

A sensitizer absorbs specific actinic radiation and attains an electronically excited state. The sensitizer that has attained an electronically excited state causes electron transfer, energy transfer, heat generation, etc. by contacting a photopolymerization initiator, thereby promoting chemical change of the photopolymerization initiator, that is, decomposition and generation of a radical, acid, or base.

Moreover, when the coating composition of the present invention is used as an overprint, the sensitizer that can be used in the present invention is preferably a compound for which an effect such as coloration is small, or is used in a small amount.

The content of the sensitizer in the present invention, relative to the total weight of the coating composition, is preferably 0.001 to 5 wt %, and more preferably 0.01 to 3 wt %. When the amount added is in this range, curability improves and any coloration effect is small.

As the sensitizer, a compound selected according to the wavelength of actinic radiation used for generating an initiating species by a photopolymerization initiator may be used, but when taking into consideration that it is used in a curing reaction of a general coating composition, as preferred examples of the sensitizer, those belonging to the compound types below and having an absorption wavelength in the region of 350 nm to 450 nm can be cited.

Polynuclear aromatic compounds (e.g. pyrene, perylene, triphenylene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavin, acriflavine), anthraquinones (e.g. anthraquinone), squaryliums (e.g. squarylium), coumarins (e.g. 7-diethylamino-4-methylcoumarin), and benzophenones (e.g. benzophenon).

Preferred examples of the sensitizing dye include compounds represented by Formulae (II) to (VI) below.

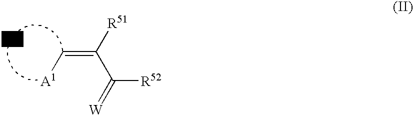

In Formula (II), A¹ denotes a sulfur atom or NR⁵⁰, R⁵⁰ denotes an alkyl group or an aryl group, L² denotes a non-metallic atomic group forming a basic nucleus of a dye in cooperation with a neighboring A¹ and the neighboring carbon atom, R⁵¹ and R⁵² independently denote a hydrogen atom or a monovalent non-metallic atomic group, and R⁵¹ and R⁵² may be bonded together to form an acidic nucleus of a dye. W denotes an oxygen atom or a sulfur atom.

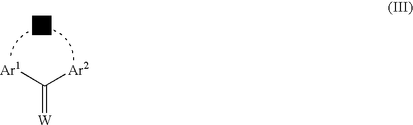

In Formula (III), Ar¹ and Ar² independently denote an aryl group and are connected to each other via a bond of -L³-. Here, L³ denotes —O— or —S—. W has the same meaning as that shown in Formula (II).

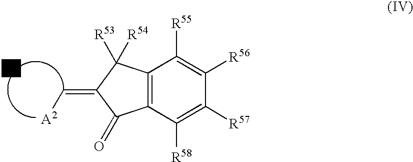

In Formula (IV), A² denotes a sulfur atom or NR⁵⁹, L⁴ denotes a non-metallic atomic group forming a basic nucleus of a dye in cooperation with the neighboring A₂ and carbon atom, R⁵³, R⁵⁴, R⁵⁵, R⁵⁶, R⁵⁷, and R⁵⁸ independently denote a monovalent non-metallic atomic group, and R⁵⁹ denotes an alkyl group or an aryl group.

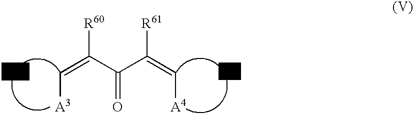

In Formula (V), A³ and A⁴ independently denote —S—, —NR⁶²—, or —NR⁶³—, R⁶² and R⁶³ independently denote a substituted or unsubstituted alkyl group, or a substituted or unsubstituted aryl group, L⁵ and L⁶ independently denote a non-metallic atomic group forming a basic nucleus of a dye in cooperation with the neighboring A³ and A⁴ and neighboring carbon atom, and R⁶⁰ and R⁶¹ independently denote a hydrogen atom or a monovalent non-metallic atomic group, or are bonded to each other to form an aliphatic or aromatic ring.

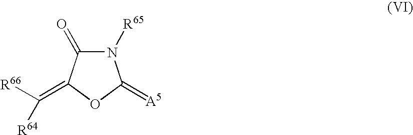

In Formula (VI), R⁶⁶ denotes an aromatic ring or a hetero ring, which may have a substituent, and A⁵ denotes an oxygen atom, a sulfur atom, or —NR⁶⁷—. R⁶⁴, R⁶⁵, and R⁶⁷ independently denote a hydrogen atom or a monovalent non-metallic atomic group, and R⁶⁷ and R⁶⁴, and R⁶⁵ and R⁶⁷ may be bonded to each other to form an aliphatic or aromatic ring.

Specific preferred examples of the compound represented by Formula (II) or (VI) are listed below. In the specific examples below, Ph denotes a phenyl group, Me denotes a methyl group.

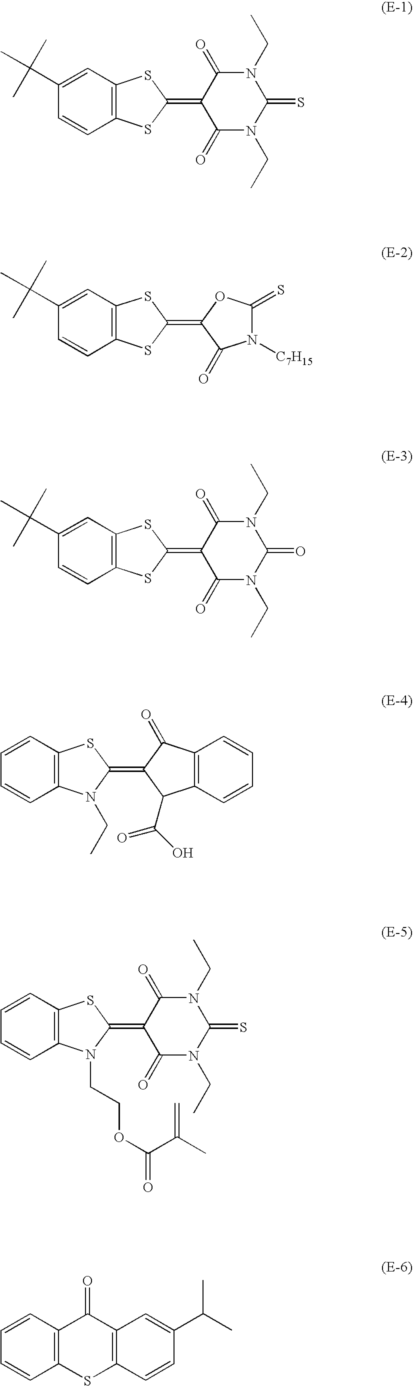

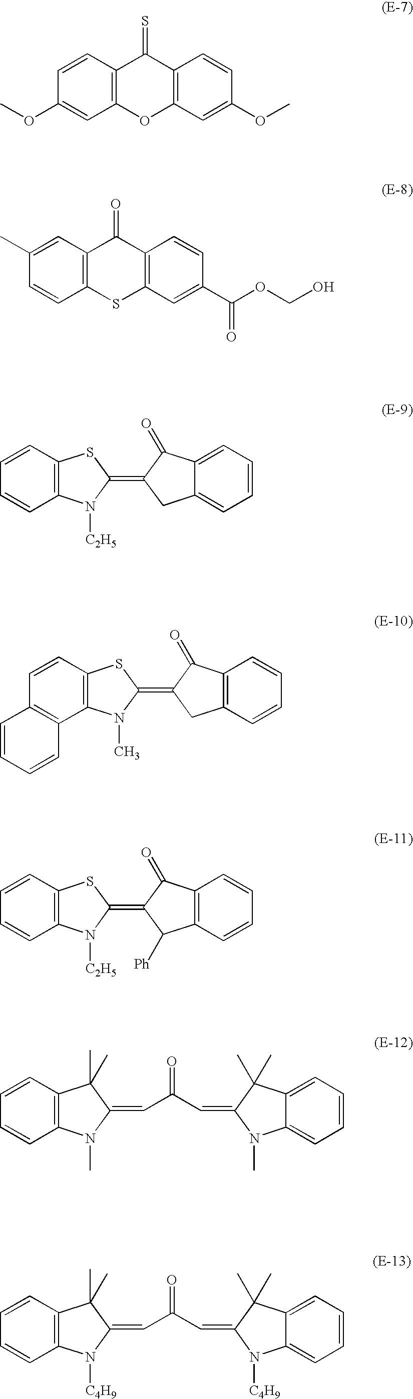

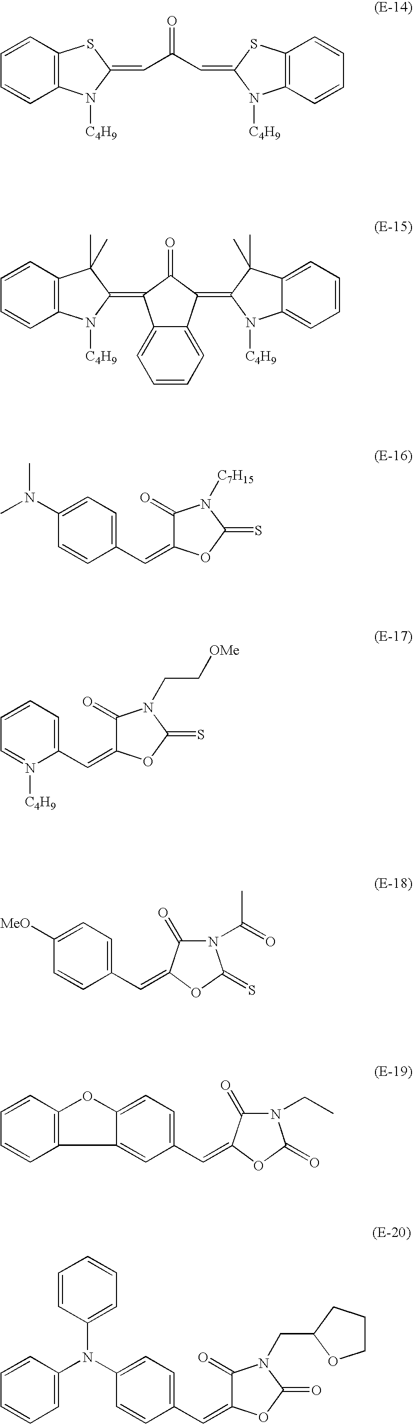

### Co-Sensitizer

The coating composition of the present invention may comprise a co-sensitizer.

In the present invention, the co-sensitizer has a function of further improving the sensitivity of a sensitizer toward actinic radiation, suppressing inhibition of polymerization of a polymerizable compound by oxygen, etc.

Examples of such a co-sensitizer include amines such as compounds described in M. R. Sander et al., Journal of Polymer Society, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure 33825.

Specific examples thereof include triethanolamine, ethyl p-dimethylaminobenzoate, p-formyldimethylaniline, and p-methylthiodimethylaniline.

Other examples of the co-sensitizer include thiols and sulfides such as thiol compounds described in JP-A-53-702, JP-PCT-55-500806 (JP-PCT denotes a published Japanese translation of a PCT application), and JP-A-5-142772, and disulfide compounds described in JP-A-56-75643.

Specific examples thereof include 2-mercaptobenzothiazole, 2-mercaptobenzoxazole, 2-mercaptobenzoimidazole, 2-mercapto-4(3H)-quinazoline, and β-mercaptonaphthalene.

Other examples thereof include amino acid compounds (e.g. N-phenylglycine), organometallic compounds described in JP-B-48-42965 (e.g. tributyltin acetate), hydrogen donors described in JP-B-55-34414, sulfur compounds described in JP-A-6-308727 (e.g. trithiane), phosphorus compounds described in JP-A-6-250387 (e.g. diethylphosphite), and Si—H and Ge—H compounds described in JP-A-8-54735.

### Surfactant

The coating composition of the present invention may comprise a surfactant.

As the surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl aryl ethers, acetylene glycols, and polyoxyethylene/polyoxypropylene block copolymers, and cationic surfactants such as alkylamine salts and quaternary ammonium salts. An organofluoro compound or a polysiloxane compound may be used as the surfactant. The organofluoro compound is preferably hydrophobic. Examples of the organofluoro compound include fluorine-based surfactants, oil-like fluorine-based compounds (e.g. fluorine oil), solid fluorine compound resins (e.g. tetrafluoroethylene resin), and those described in JP-B-57-9053 (paragraphs 8 to 17) and JP-A-62-135826. Among them, polydimethylsiloxane is preferable as the surfactant.

With regard to these surfactants, one type thereof may be used on its own or two or more types may be used in combination.

The content of the surfactants is preferably 0.1-10 percents by weight of the coating composition, and more preferably 0.5-5 percents by weight, and yet more preferably 1-3 percents by weight.

### Other Components

Other components may be added to the coating composition of the present invention as necessary. Examples of said other components include a polymerization inhibitor, a solvent, inorganic particles, and organic particles.

The polymerization inhibitor may be added from the viewpoint of enhancing the storage stability. The polymerization inhibitor is preferably added at 200 to 20,000 ppm relative to the total amount of the coating composition of the present invention.

Examples of the polymerization inhibitor include hydroquinone, benzoquinone, p-methoxyphenol, TEMPO, TEMPOL, and Al cupferron.

It is possible to form an overprint layer or an overprint with intentionally degraded surface gloss by adding inorganic particles such as AEROSIL (silicon dioxide particles, manufactured by Degussa Inc.) or organic particles such as crosslinked polymethyl methacrylate (PMMA) to the coating composition of the present invention.

Taking into consideration the coating composition of the present invention being a radiation curable type coating composition, it is preferable for it not to contain any solvent so that the coating composition of the present invention can react quickly and be cured after coating. However, as long as the curing speed, etc. of the coating composition is not greatly affected, a specified solvent may be added.

In the present invention, an organic solvent may be used as the solvent, and from the viewpoint of curing speed, it is preferable for substantially no water to be added. The organic solvent may be added in order to improve adhesion to a printing substrate (an image receiving substrate such as paper).

When an organic solvent is used, the smaller the amount thereof, the more preferable it is, and it is preferably 0.1 to 5 wt % relative to the total weight of the coating composition of the present invention, and more preferably 0.1 to 3 wt %.

In addition to the above, a known compound may be added to the coating composition of the present invention as necessary.

Examples thereof include a leveling additive, a matting agent and, for adjusting film physical properties, a polyester-based resin, polyurethane-based resin, vinyl-based resin, acrylic-based resin, rubber-based resin, or wax, which may be appropriately selected and added.

Furthermore, in order to improve the adhesion to a printing substrate such as a polyolefin or polyethylene terephthalate (PET), a tackifier that does not inhibit polymerization is preferably added. Specific examples of the tackifier include high molecular weight tacky polymers described on pp. 5 and 6 of JP-A-2001-49200 (e.g. a copolymer formed from an ester of (meth)acrylic acid and an alcohol having an alkyl group having 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having an ethylenically unsaturated bond.

### Properties of Photocurable Coating Composition

Preferred physical properties of the photocurable coating composition of the present invention are now explained.

When used as a photocurable coating composition, while taking into consideration coating properties, the viscosity at 25° C. to 30° C. is preferably 5 to 100 mPa·s, and more preferably 7 to 75 mPa·s.

The compositional ratio of the photocurable coating composition of the present invention is preferably adjusted as appropriate so that the viscosity is in the above range.

Setting the viscosity at 25° C. to 30° C. at the above value enables an overprint having an overprint layer with excellent non-tackiness (no surface tackiness) and excellent surface smoothness to be obtained.

The surface tension of the photocurable coating composition of the present invention is preferably 16 to 40 mN/m, and more preferably 18 to 35 mN/m.

### Overprint and Process for Producing Same

The overprint of the present invention has, on a printed material, an overprint layer in which the coating composition of the present invention is photocured.

The overprint referred to here is one in which at least one overprint layer is formed on the surface of a printed material obtained by a printing method such as electrophotographic printing, inkjet printing, screen printing, flexographic printing, lithographic printing, intaglio printing, or relief printing.

The overprint layer in the overprint of the present invention may be formed on part of a printed material or may be formed on the entire surface of a printed material, and in the case of a double-side printed material, it is preferable to form the overprint layer on the entire surface of a printing substrate on both sides. Furthermore, needless to say, the overprint layer may be formed on an unprinted area of a printed material.

A printed material used for the overprint of the present invention is preferably an electrophotographically printed material. Forming an overprint layer, which is a cured layer of the coating composition of the present invention, on an electrophotographically printed material enables an overprint that has excellent non-tackiness, surface smoothness, and gloss and is visually similar to a silver halide photographic print to be obtained.

A printed material used for the overprint of the present invention is preferably an electrophotographically printed material. Forming an overprint layer, which is a cured layer of the coating composition of the present invention, on an electrophotographically printed material enables an overprint that has excellent non-tackiness, surface smoothness, and gloss and is visually similar to a silver halide photographic print to be obtained.

Furthermore, since the overprint of the present invention has an excellent non-tackiness, the overprints do not stick each other and a good storage property can be obtained if a plurality of the overprints of the present invention is piled up for a long time.

The thickness of the overprint layer in the overprint of the present invention is preferably 1 to 10 μm, and more preferably 3 to 6 μm.

The process for producing an overprint of the present invention preferably comprises a step of obtaining a printed material by carrying out printing on a printing substrate, a step of coating the printed material with the photocurable coating composition of the present invention, and a step of photocuring the photocurable coating composition.

Furthermore, the process for producing an overprint of the present invention preferably comprises a step of generating an electrostatic latent image on a latent image support, a step of developing the electrostatic latent image using a toner, a step of obtaining an electrophotographically printed material by transferring the developed electrostatic image onto a printing substrate, a step of coating the electrophotographically printed material with the photocurable coating composition of the present invention, and a step of photocuring the photocurable coating composition.

The printing substrate is not particularly limited, and a known substrate may be used, but an image receiving paper is preferable, plain paper or coated paper is more preferable, and coated paper is yet more preferable. As the coated paper, a double-sided coated paper is preferable since a full color image can be attractively printed on both sides. When the printing substrate is paper or a double-sided coated paper, the paper weight is preferably 20 to 200 g/m², and more preferably 40 to 160 g/m².

A method for developing an image in the electrophotographic process is not particularly limited, and any method may be selected from methods known to a person skilled in the art. Examples thereof include a cascade method, a touch down method, a powder cloud method, and a magnetic brush method.

Furthermore, examples of a method for transferring a developed image to a printing substrate include a method employing a corotron or a bias roll.

A fixing step of fixing an image in the electrophotographic process may be carried out by various appropriate methods. Examples thereof include flash fixing, thermal fixing, pressure fixing, and vapor fusing.

The image formation method, equipment, and system in the electrophotographic process are not particularly limited, and known ones may be used. Specific examples are described in the U.S. patents below.

U.S. Pat. Nos. 4,585,884, 4,584,253, 4,563,408, 4,265,990, 6,180,308, 6,212,347, 6,187,499, 5,966,570, 5,627,002, 5,366,840, 5,346,795, 5,223,368, and 5,826,147.

In order to apply the photocurable coating composition, a commonly used liquid film coating device may be used. Specific examples thereof include a roller coater, a rod coater, a blade, a wire-wound bar, a dip coater, an air knife, a curtain coater, a slide coater, a doctor knife, a screen coater, a gravure coater, an offset gravure coater, a slot coater, and an extrusion coater. These devices may be used in the same manner as normal, and examples thereof include direct and reverse roll coating, blanket coating, dampener coating, curtain coating, lithographic coating, screen coating, and gravure coating. In a preferred embodiment, application and curing of the coating composition of the present invention are carried out using 2 or 3 roll coaters and UV curing stations.

Moreover, when coating or curing the coating composition of the present invention, heating may be carried out as necessary.

The coat weight of the coating composition of the present invention is preferably in the range of 1 to 10 g/m² as a weight per unit area, and more preferably 3 to 6 g/m².

Furthermore, the amount per unit area of an overprint layer formed in the overprint of the present invention is preferably in the range of 1 to 10 g/m², and more preferably 3 to 6 g/m².

As an energy source used for initiating polymerization of the polymerizable compound contained in the coating composition of the present invention, for example, one having actinism (actinic radiation) such as radiation having a wavelength in the UV or visible spectrum can be cited. Polymerization by irradiation with actinic radiation is excellent for initiating polymerization and regulating the speed of polymerization.

As a preferred actinic radiation source, for example, there are a mercury lamp, a xenon lamp, a carbon arc lamp, a tungsten filament lamp, a laser, and sunlight.

It is preferable to carry out irradiation using a high speed conveyor (preferably 20 to 70 m/min) under irradiation with UV rays (UV light irradiation) using a medium pressure mercury lamp, and in this case UV light irradiation is preferably carried out at a wavelength of 200 to 500 nm for less than 1 sec. Preferably, the speed of the high speed conveyor is 15 to 35 m/min, and UV light having a wavelength of 200 to 450 nm is applied for 10 to 50 milliseconds (ms). The emission spectrum of a UV light source normally overlaps the absorption spectrum of a UV polymerization initiator. Depending on the situation, curing equipment used may include, without being limited to, a reflection plate for focusing or diffusing UV light or a cooling system for removing heat generated by a UV light source.

### Properties of Cured Material of Photocurable Coating

A cured material formed by curing the photocurable coating composition of the present invention by irradiation with UV rays (UV light irradiation) preferably has substantially no absorption in the visible region. ‘Having substantially no absorption in the visible region’ means either having no absorption in the visible region of 400 to 700 nm or having only a level of absorption in the visible region that does not cause any problem as a photocurable coating. Specifically, a 5 μm optical path length transmittance of the coating composition in the wavelength region of 400 to 700 nm is at least 70%, and preferably at least 80%.

In accordance with the present invention, there can be provided a photocurable coating composition giving excellent surface smoothness, non-tackiness (suppression of surface tackiness), and suppression of odor, an overprint obtained by using the photocurable coating composition, and a process for producing same.

### EXAMPLES

The present invention is explained more specifically below by reference to Examples, but the present invention should not be construed as being limited by modes of these Examples.

### Example 1

The components below were stirred using a stirrer to give photocurable coating composition 1.

| | | |
|---|---|---|
| FA-513A (Hitachi Chemical Co., Ltd.) | 25 | wt % |
| 2-Phenoxyethyl acrylate (Tokyo Chemical Industry Co., Ltd.) | 25 | wt % |
| N-Vinylcaprolactam (Aldrich) | 20 | wt % |
| Hexyl acrylate | 15 | wt % |
| Specific initiator (I-1) | 13 | wt % |
| Polydimethylsiloxane (Aldrich) | 2 | wt % |

FA-513A

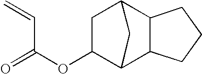

### Examples 2 to 15

In Examples 2 to 15, photocurable coating compositions 2 to 15 were obtained in the same manner as in Example 1 except that specific initiator (I-1) of Example 1 was changed to a compound shown in Table 1.

### Example 16

The components below were stirred using a stirrer to give photocurable coating composition 16.

| | | |
|---|---|---|
| Tripropylene glycol diacrylate (Aldrich) | 30 | wt % |
| Lauryl acrylate (Tokyo Chemical Industry Co., Ltd.) | 15 | wt % |
| OTA-480 (Cytec Surface Specialties) | 25 | wt % |
| Hexyl acrylate | 15 | wt % |
| Specific initiator (I-1) | 13 | wt % |
| Polydimethylsiloxane (Aldrich) | 2 | wt % |

OTA-480

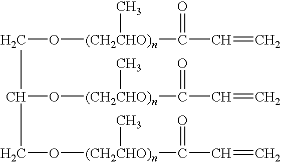

### Examples 17 to 33

In Examples 17 to 33, photocurable coating compositions 17 to 33 were obtained in the same manner as in Example 16 except that specific initiator (I-1) of Example 16 was changed to a compound shown in Table 1.

### Example 34

The components below were stirred using a stirrer to give photocurable overprint composition 34.

| | | |
|---|---|---|
| Tripropylene glycol diacrylate (Aldrich) | 30 | wt % |
| NK Ester A-TMPT (Shin-Nakamura Chemical Co., Ltd) | 10 | wt % |
| DPCA-60 (Nippon Kayaku Co., Ltd.) | 10 | wt % |
| Lauryl acrylate (Tokyo Chemical Industry Co., Ltd.) | 20 | wt % |
| Hexyl acrylate | 15 | wt % |
| Specific initiator (I-1) | 13 | wt % |
| Polydimethylsiloxane (Aldrich) | 2 | wt % |

NK Ester A-TMPT

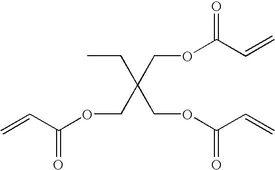

DPCA-60

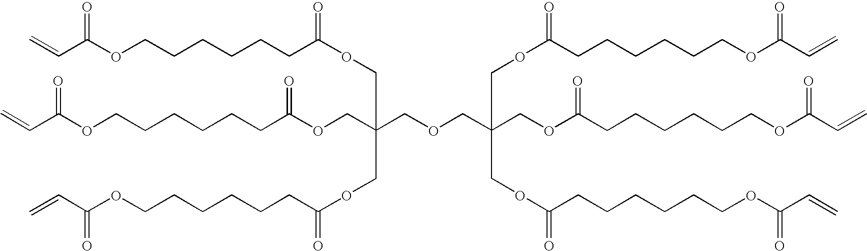

### Example 35 (Cationic Curing System)

The components below were stirred using a stirrer to give photocurable overprint composition 35.

| | | |
|---|---|---|
| Celloxide 2021A (Daicel-UCB Co., Ltd.) | 20 | wt % |
| (3,4-epoxycyclohexylmethyl | | |
| 3′,4′-epoxycyclohexanecarboxylate) | | |
| OXT-221 (Toagosei Co., Ltd.) | 45 | wt % |
| (3,7-bis(3-oxetanyl)-5-oxanonane) | | |
| OXT-211 (Toagosei Co., Ltd.) | 20 | wt % |
| (3-ethyl-3-phenoxymethyloxetane) | | |
| Specific initiator (I-1) | 13 | wt % |
| 9,10-Dibutoxyanthracene | 2 | wt % |

Celloxide 2021A

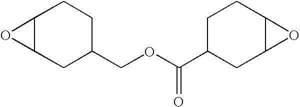

OXT-221

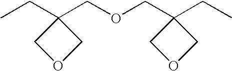

OXT-211

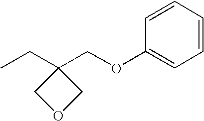

### Comparative Example 1

The components below were stirred using a stirrer to give comparative photocurable coating composition 1.

| | | |
|---|---|---|
| FA-513A (Hitachi Chemical Co., Ltd.) | 25 | wt % |
| 2-Phenoxyethyl acrylate (Tokyo Chemical Industry Co., Ltd.) | 25 | wt % |
| N-Vinylcaprolactam (Aldrich) | 20 | wt % |
| Hexyl acrylate | 15 | wt % |
| Comparative compound HA | 13 | wt % |
| Polydimethylsiloxane (Aldrich) | 2 | wt % |

HA

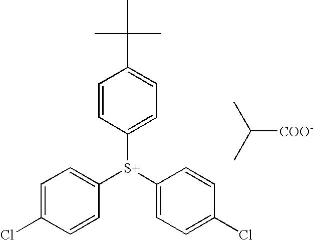

### Comparative Example 2

The components below were stirred using a stirrer to give comparative photocurable coating composition 2.

| | | |
|---|---|---|
| FA-513A (Hitachi Chemical Co., Ltd.) | 25 | wt % |
| 2-Phenoxyethyl acrylate (Tokyo Chemical Industry Co., Ltd.) | 25 | wt % |
| N-Vinylcaprolactam (Aldrich) | 20 | wt % |
| Hexyl acrylate | 15 | wt % |
| Comparative compound HB | 13 | wt % |
| Polydimethylsiloxane (Aldrich) | 2 | wt % |

HB

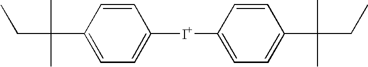

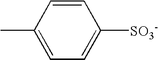

### Comparative Example 3

The components below were stirred using a stirrer to give comparative photocurable coating composition 3.

| | | |
|---|---|---|
| FA-513A (Hitachi Chemical Co., Ltd.) | 25 | wt % |
| 2-Phenoxyethyl acrylate (Tokyo Chemical Industry Co., Ltd.) | 25 | wt % |
| N-Vinylcaprolactam (Aldrich) | 20 | wt % |
| Hexyl acrylate | 15 | wt % |
| Comparative compound HC | 13 | wt % |
| Polydimethylsiloxane (Aldrich) | 2 | wt % |

HC

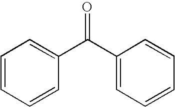

### Comparative Example 4

The components below were stirred using a stirrer to give comparative photocurable coating composition 4.

| | | |
|---|---|---|
| FA-513A (Hitachi Chemical Co., Ltd.) | 25 | wt % |
| 2-Phenoxyethyl acrylate (Tokyo Chemical Industry Co., Ltd.) | 25 | wt % |
| N-Vinylcaprolactam (Aldrich) | 20 | wt % |
| Hexyl acrylate | 15 | wt % |
| Comparative compound HD | 13 | wt % |
| Polydimethylsiloxane (Aldrich) | 2 | wt % |

HD

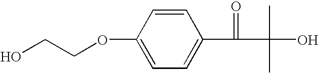

### Comparative Example 5

The components below were stirred using a stirrer to give comparative photocurable coating composition 5.

| | |
|---|---|
| FA-513A (Hitachi Chemical Co., Ltd.) | 25 wt % |
| 2-Phenoxyethyl acrylate (Tokyo Chemical Industry Co., Ltd.) | 25 wt % |
| N-Vinylcaprolactam (Aldrich) | 20 wt % |
| Hexyl acrylate | 23 wt % |
| Comparative compound HD | 5 wt % |
| Polydimethylsiloxane (Aldrich) | 2 wt % |

### Comparative Example 6

The components below were stirred using a stirrer to give comparative photocurable coating composition 6.

| | |
|---|---|
| Tripropylene glycol diacrylate (Aldrich) | 30 wt % |
| Lauryl acrylate (Tokyo Chemical Industry Co., Ltd.) | 15 wt % |
| OTA-480 (Cytec Surface Specialties) | 25 wt % |
| Hexyl acrylate | 15 wt % |
| Comparative compound HA | 13 wt % |
| Polydimethylsiloxane (Aldrich) | 2 wt % |

### Comparative Example 7

The components below were stirred using a stirrer to give comparative photocurable coating composition 7.

| | |
|---|---|
| Tripropylene glycol diacrylate (Aldrich) | 30 wt % |
| Lauryl acrylate (Tokyo Chemical Industry Co., Ltd.) | 15 wt % |
| OTA-480 (Cytec Surface Specialties) | 25 wt % |
| Hexyl acrylate | 15 wt % |
| Comparative compound HB | 13 wt % |
| Polydimethylsiloxane (Aldrich) | 2 wt % |

### Comparative Example 8

The components below were stirred using a stirrer to give comparative photocurable coating composition 8.

| | |
|---|---|
| Tripropylene glycol diacrylate (Aldrich) | 30 wt % |
| Lauryl acrylate (Tokyo Chemical Industry Co., Ltd.) | 15 wt % |
| OTA-480 (Cytec Surface Specialties) | 25 wt % |
| Hexyl acrylate | 15 wt % |
| Comparative compound HC | 13 wt % |
| Polydimethylsiloxane (Aldrich) | 2 wt % |

### Comparative Example 9

The components below were stirred using a stirrer to give comparative photocurable coating composition 9.

| | |
|---|---|
| Tripropylene glycol diacrylate (Aldrich) | 30 wt % |
| Lauryl acrylate (Tokyo Chemical Industry Co., Ltd.) | 15 wt % |
| OTA-480 (Cytec Surface Specialties) | 25 wt % |
| Hexyl acrylate | 15 wt % |
| Comparative compound HD | 13 wt % |
| Polydimethylsiloxane (Aldrich) | 2 wt % |

### Comparative Example 10

The components below were stirred using a stirrer to give comparative photocurable coating composition 10.

| | |
|---|---|
| Tripropylene glycol diacrylate (Aldrich) | 30 wt % |
| Lauryl acrylate (Tokyo Chemical Industry Co., Ltd.) | 15 wt % |
| OTA-480 (Cytec Surface Specialties) | 25 wt % |
| Hexyl acrylate | 23 wt % |
| Comparative compound HD | 5 wt % |
| Polydimethylsiloxane (Aldrich) | 2 wt % |

### Comparative Example 11

The components below were stirred using a stirrer to give comparative photocurable coating composition 11.

| | |
|---|---|
| Tripropylene glycol diacrylate (Aldrich) | 30 wt % |
| NK Ester A-TMPT (Shin-Nakamura Chemical Co., Ltd.) | 10 wt % |
| DPCA-60 (Nippon Kayaku Co., Ltd.) | 10 wt % |
| Lauryl acrylate (Tokyo Chemical Industry Co., Ltd.) | 20 wt % |
| Hexyl acrylate | 15 wt % |
| Comparative compound HA | 13 wt % |
| Polydimethylsiloxane (Aldrich) | 2 wt % |

### Comparative Example 12

The components below were stirred using a stirrer to give comparative photocurable coating composition 12.

| | |
|---|---|
| Celloxide 2021A (Daicel-UCB Co., Ltd.) | 20 wt % |
| (3,4-epoxycyclohexylmethyl 3′,4′- | |
| epoxycyclohexanecarboxylate) | |
| OXT-221 (Toagosei Co., Ltd.) | 45 wt % |
| (3,7-bis(3-oxetanyl)-5-oxanonane) | |
| OXT-211 (Toagosei Co., Ltd.) | 20 wt % |
| (3-ethyl-3-phenoxymethyloxetane) | |
| Comparative compound HA | 13 wt % |
| 9,10-Dibutoxyanthracene | 2 wt % |

### Evaluation of Performance

The performance of the photocurable coating compositions thus obtained was evaluated by the methods below.

### Evaluation of Surface Smoothness (Leveling Properties)

An electrophotographically printed material, obtained using double-sided coated paper, output from a DC8000 digital printer manufactured by Fuji Xerox Co., Ltd. was coated on one side at a film thickness of 5 g/m² using an SG610V UV varnish coater manufactured by Shinano Kenshi Co., Ltd. The condition of the surface of the coated printed material was visually evaluated in terms of the occurrence of longitudinal lines. The evaluation criteria are shown below.

Excellent: no longitudinal lines
Good: slight longitudinal lines remained
Poor: many longitudinal lines observed

### Evaluation of Non-Tackiness (Suppression of Surface Tackiness)

An electrophotographically printed material, obtained using double-sided coated paper, output from a DC8000 digital printer manufactured by Fuji Xerox Co., Ltd. was coated on one side with the coating composition at a film thickness of 5 g/m² using a bar coater, and the film coating thus obtained was exposed at 120 mJ/cm² with an illumination intensity of 1.0 W/cm² using an LC8 UV lamp manufactured by Hamamatsu Photonics K. K., thus giving an overprint sample. The non-tackiness after exposure was evaluated by touch. The evaluation criteria are shown below.

Excellent: no tackiness
Good: almost no tackiness
Fair: some tackiness
Poor: tacky

### Evaluation of Odor

An electrophotographically printed material, obtained using double-sided coated paper, output from a DC8000 digital printer manufactured by Fuji Xerox Co., Ltd. was coated on one side with the coating composition at a film thickness of 5 g/m² using an SG610V UV varnish coater manufactured by Shinano Kenshi Co., Ltd., and then allowed to stand for 1 hour, the printed material thus obtained was subjected to sensory evaluation by sensing odor, and the level of odor was evaluated according to the criteria below.

Evaluation was carried out by eight expert panelists using the criteria below (evaluation points).

Evaluation criteria (evaluation points):
5 (points): 8 out of 8 people recognized effect in reducing odor.
4 (points): 6 to 7 out of 8 people recognized effect in reducing odor.
3 (points): 4 to 5 out of 8 people recognized effect in reducing odor.
2 (points): 1 to 3 out of 8 people recognized effect in reducing odor.
1 (point): effect in reducing odor was not recognized.

When the number of evaluation points was at least 4, it was considered that there would be no problem in practice.

TABLE 1

| | Specific | | | | |
|---|---|---|---|---|---|
| | compound | Molecular | Surface | Non- | |
| | Example | weight | smoothness | tackiness | Odor |
| Example 1 | I-1 | 6,300 | Excellent | Excellent | 5 |
| Example 2 | I-3 | 11,000 | Excellent | Good | 5 |
| Example 3 | I-4 | 21,500 | Excellent | Excellent | 5 |
| Example 4 | I-6 | 21,000 | Excellent | Good | 4 |
| Example 5 | I-7 | 15,000 | Excellent | Excellent | 5 |
| Example 6 | I-10 | 23,000 | Excellent | Excellent | 5 |
| Example 7 | II-1 | 18,000 | Excellent | Excellent | 5 |
| Example 8 | II-8 | 11,000 | Excellent | Excellent | 5 |
| Example 9 | II-14 | 12,000 | Excellent | Excellent | 5 |
| Example 10 | III-1 | 8,000 | Excellent | Excellent | 5 |
| Example 11 | N-1 | 11,000 | Excellent | Good | 4 |
| Example 12 | N-8 | 15,000 | Excellent | Good | 4 |
| Example 13 | N-13 | 22,000 | Excellent | Good | 4 |
| Example 14 | N-15 | 23,000 | Excellent | Fair | 4 |
| Example 15 | N-25 | 25,000 | Excellent | Fair | 4 |
| Example 16 | I-1 | 6,300 | Good | Excellent | 5 |
| Example 17 | I-3 | 11,000 | Good | Good | 5 |
| Example 18 | I-5 | 16,000 | Good | Excellent | 5 |
| Example 19 | I-9 | 8,000 | Good | Good | 5 |
| Example 20 | I-13 | 31,000 | Good | Good | 4 |
| Example 21 | I-15 | 19,000 | Good | Good | 4 |
| Example 22 | II-2 | 9,000 | Good | Good | 5 |
| Example 23 | II-11 | 22,000 | Good | Good | 5 |
| Example 24 | II-16 | 9,300 | Good | Good | 5 |
| Example 25 | IV-2 | 20,000 | Good | Good | 4 |
| Example 26 | N-2 | 20,000 | Good | Good | 5 |
| Example 27 | N-6 | 9,000 | Good | Good | 4 |
| Example 28 | N-22 | 14,000 | Good | Good | 4 |
| Example 29 | N-15 | 23,000 | Good | Fair | 4 |
| Example 30 | N-25 | 25,000 | Good | Fair | 4 |
| Example 31 | N-26 | 30,000 | Excellent | Fair | 4 |
| Example 32 | N-29 | 13,000 | Excellent | Fair | 4 |
| Example 33 | N-30 | 15,000 | Excellent | Fair | 4 |
| Example 34 | I-1 | 6,300 | Fair | Excellent | 4 |
| Example 35 | I-1 | 6,300 | Excellent | Good | 5 |
| Comp. Ex. 1 | HA | — | Excellent | Fair | 1 |
| Comp. Ex. 2 | HB | — | Excellent | Fair | 1 |
| Comp. Ex. 3 | HC | — | Excellent | Poor | 1 |
| Comp. Ex. 4 | HD | — | Excellent | Poor | 1 |
| Comp. Ex. 5 | HD | — | Excellent | Poor | 3 |
| Comp. Ex. 6 | HA | — | Good | Fair | 1 |
| Comp. Ex. 7 | HB | — | Good | Fair | 1 |
| Comp. Ex. 8 | HC | — | Good | Poor | 1 |
| Comp. Ex. 9 | HD | — | Good | Poor | 1 |
| Comp. Ex. 10 | HD | — | Good | Poor | 3 |
| Comp. Ex. 11 | HA | — | Fair | Fair | 1 |
| Comp. Ex. 12 | HA | — | Excellent | Fair | 1 |

In Examples 1 to 35 above, the amount of overprint layer formed by coating one side of a printing substrate with a photocurable coating composition at a coat weight of 5 g/m² and curing it was 5 g/m² in each case.

Furthermore, the thickness of the overprint layer thus formed was about 5 μm in each case. The thickness of the overprint layer thus formed was measured by examining a cross section of the overprint using an optical microscope.

### Evaluation of Transmittance

When the transmittance at an optical path length of 5 μm of the photocurable coating compositions used in Examples 1 to 35 was measured, the transmittance was 80% over the whole wavelength region of 400 nm to 700 nm in all cases.

When the transmittance at an optical path length of 5 μm of the cured material formed by the photocurable coating compositions used in Examples 1 to 35 was measured, the transmittance was 80% over the whole wavelength region of 400 nm to 700 nm in all cases.

### Example 36

20 sheets of printed material were prepared by electrophotographically printing full color images, each having a few frames, on both sides of A4 double-sided coated paper (paper weight 100 g/m²), both sides of the printed materials were coated with the photocurable coating compositions prepared in Examples 1 to 35 above by the same method as in Example 1 at a coat weight of 5 g/m², and then irradiated with UV rays, thus giving overprints. When they were bound to give a photo album together with a cover, a photo album giving the same visibility as that given by a silver halide photographic print was obtained.

### Example 37

Full color images and text including a menu photograph were electrophotographically printed on both sides of 10 sheets of A4 double-sided coated paper (paper weight 100 g/m²). Both sides of the printed materials were coated with the photocurable coating compositions prepared in Examples 1 to 35 above by the same method as in Example 1 at a coat weight of 5 g/m², and then irradiated with UV rays, thus giving double-sided overprints. When they were bound to give a restaurant menu, a restaurant menu giving the same visibility as that given by a silver halide photographic print was obtained.

1. A photocurable coating composition comprising:
(A) a photopolymerization initiator residue-containing polymer compound; and
(B) a polymerizable compound.

2. The photocurable coating composition according to claim 1, wherein a photopolymerization initiator residue-containing monomer unit of the polymer compound comprises a residue selected from the group consisting of an onium salt, a borate salt, an imide structure-containing compound, a triazine structure-containing compound, an azo compound, a peroxide, a lophine dimer, and a benzoyl compound.

3. The photocurable coating composition according to claim 1, wherein a photopolymerization initiator residue-containing monomer unit of the polymer compound has a content of 40 to 60 mole %.

4. The photocurable coating composition according to claim 1, wherein the polymer compound has a weight-average molecular weight of at least 1,000 but no greater than 100,000.

5. The photocurable coating composition according to claim 1, wherein the polymer compound has a content, relative to the solids content of the photocurable coating composition, of at least 1 wt % but no greater than 40 wt %.

6. The photocurable coating composition according to claim 1, wherein it has substantially no absorption in the visible region.

7. An overprint comprising an overprint layer formed by photocuring the photocurable coating composition according to claim 1 on a printed material.

8. The overprint according to claim 7, wherein the overprint layer has a thickness of at least 1 μm but no greater than 10 μm.

9. The overprint according to claim 7, wherein the overprint layer has substantially no absorption in the visible region.

10. An overprint comprising an overprint layer formed by photocuring the photocurable coating composition according to claim 1 on an electrophotographically printed material.

11. The overprint according to claim 10, wherein the overprint layer has a thickness of at least 1 μm but no greater than 10 μm.

12. The overprint according to claim 12, wherein the overprint layer has substantially no absorption in the visible region.

13. A process for producing an overprint, the process comprising:
a step of coating a printed material with the photocurable coating composition according to claim 1; and
a step of photocuring the photocurable coating composition.

14. A process for producing an overprint, the process comprising:
a step of obtaining an electrophotographically printed material by carrying out electrophotographic printing on a printing substrate;
a step of coating the electrophotographically printed material with the photocurable coating composition according to claim 1; and
a step of photocuring the photocurable coating composition.
